(19) United States
(12) Patent Application Publication
(10) Pub. No.: US 2004/0259636 A1
(43) Pub. Date: Dec. 23, 2004

(54) Gaming machine and computer-readable program product

(75) Inventor: Matsuzo Machida, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 10/869,897

(22) Filed: Jun. 18, 2004

(30) Foreign Application Priority Data
Jun. 19, 2003 (JP) P2003-175618

(51) Int. Cl. A63F 13/00

(52) U.S. Cl. 463/30

(57) ABSTRACT

A gaming program causes a computer to function as status change control means (for example, CPU21, ROM 22, RAM 23, DVD-ROM 31, memory card 32, etc., and in particular, “status table” in FIG. 37, “main character status change processing” in FIG. 36, etc.,) for changing the status of a player character (for example, “status” of specific main character, status of “biorhythm,” etc.,) if a predetermined condition is satisfied (for example, YES at ST111, ST115, ST117 in FIG. 36, execution of ST114, etc.,).

### CROSS-REFERENCE TO THE RELATED APPLICATION(S)

This application is based upon and claims a priority from prior Japanese Patent Application No. 2003-175618 filed on Jun. 19, 2003, the entire contents of which are incorporated herein by reference. This application is related to co-pending U.S. applications claiming priorities on JP-2003-175620, JP-2003-175622, JP-2003-175623, JP-2003-175064, JP-2003-175065, JP-2003-175066, JP-2003-175136 and JP-2003-175137, and filed on even date herewith. The co-pending applications are expressly incorporated herein by reference.

### BACKGROUND OF THE INVENTION

1. Field of the Invention

The present invention relates to a gaming program, a gaming machine, and a record medium recording the gaming program and in particular to a gaming program and a gaming machine for displaying a plurality of characters on a display screen and allowing a player to select the action mode of the character, thereby proceeding a game, and a record medium recording the gaming program.

2. Description of the Related Art

Hitherto, various games have been provided for a player to enter commands through operation unit such as a controller to handle a character in the game in a virtual world in the game on a screen of a computer or a television, and proceed a preset story. Such a game is generally called “RPG” (Role Playing Game).

The following RPG is generally known: A battle scene in which a character handled by a player, which will be hereinafter referred to as the main character, and an enemy character controlled by a computer fight a battle is included and the player beats the enemy character in the battle, thereby obtaining an experiment value or virtual money, and proceeds the story whiling raising the character level.

In the battle scene in this kind of RPG, the attack made by the main character is uniquely determined by settings of the skill responsive to the level of the main character, the attack power responsive to the possessed items (arms and spell) and the like, and the action mode of the character after command selection is automatically processed by the computer in accordance with the action control algorithm of the character contained in the game program based on the selected command.

However, in the RPG including such battle scenes, the player must repeat a large number of battles to the ending and may lack concentration or get tired because of such as fatigue, at the final stage of the game. Thus, a gaming machine for enabling the player to continue interest to the final stage of the game by augmenting the interest in the whole game is proposed. (For example, refer to JP-A-2002-200334.) The gaming machine adopts a technique wherein, for example, when the player character satisfies predetermined conditions (the cumulative amount of trophy status that can be gained in the battles reaches a predetermined value and the player character fights the special enemy character and wins the battle), the player character can be transformed into the enemy character.

### SUMMARY OF THE INVENTION

However, in the gaming machine described above, the conditions for enabling the player character to be transformed into the enemy character are complicated and as the player proceeds the game to some extent, the conditions are satisfied. Thus, the number of types of transformation into the enemy character is small at the initial stage of the game and the play cannot frequently make attack with the player character transformed into the enemy character in the battle. Accordingly, the variety of the battle scenes is narrow and it is feared that the player may reduce interest in the game.

It is therefore an object of the invention to provide a gaming program, a gaming machine, and a record medium recording the gaming program for making it possible to provide multifaceted change in player characters, augment the interest in a game, expect change in the player character for repeating a battle with an enemy character, and increase the interest of the player in a battle scene.

According to a first aspect of the invention, there is provided a gaming machine for allowing a player to enter an action command of a player character to proceed a game, the gaming machine including: an operation unit that allows the player to enter the action command; a display controller that displays the player character and an enemy character on a display for displaying the progress of the game and displaying a battle between the player character and the enemy character on the display; and a status controller that changes a status of the player character when a predetermined condition is satisfied.

According to a second aspect of the invention, there is provided a computer-readable program product for storing a gaming program for causing a computer to execute the steps of: allowing a player to enter an action command of a player character to proceed a game; displaying the player character and an enemy character on a display for displaying the progress of the game and displaying a battle between the player character and the enemy character; and changing the status of the player character when a predetermined condition is satisfied.

### BRIEF DESCRIPTION OF THE DRAWINGS

These and other objects and advantages of the present invention will be more fully apparent from the following detailed description taken in conjunction with the accompanying drawings, in which:

FIG. 1 is a drawing to show the general configuration of a gaming machine incorporating the invention;

FIG. 2 is a block diagram to show the system configuration of the gaming machine in FIG. 1;

FIGS. 3A and 3B show display examples of a title screen and a world map;

FIG. 4 is a flowchart to show a procedure of main game processing;

FIG. 5 is a flowchart to show a procedure of battle processing;

FIG. 6 is a drawing to show a battle scene start screen;

FIG. 7 is a flowchart to show a procedure of WP decrement processing;

FIGS. 8A and 8B are drawings to show the character individual skills of main characters A and B;

FIG. 9 is a drawing to show a command selection screen;

FIG. 10 is a flowchart to show a procedure of command acceptance processing;

FIG. 11 is a flowchart to show a procedure of character out-of-control processing;

FIG. 12 shows a first display example when the character out-of-control processing is executed;

FIG. 13 shows a second display example when the character out-of-control processing is executed;

FIG. 14 is a flowchart to show a procedure of command processing;

FIG. 15 is a flowchart to show a procedure of judgment processing;

FIG. 16 is a drawing to show a target character selection screen;

FIG. 17 is a drawing to show a display screen at the command determination time;

FIG. 18 is a drawing to show a screen displayed when an O button is operated when a rotation bar passes through a first timing area;

FIG. 19 is a drawing to show a screen displayed when the O button is operated when the rotation bar passes through a second timing area;

FIG. 20 is a drawing to show a screen displayed when the O button is operated when the rotation bar passes through a third timing area;

FIG. 21 is a drawing to show a screen displayed when a player fails in operating the O button on the timing area;

FIG. 22 is a drawing to show a screen displayed after rotation of the rotation bar stops when a player succeeds in operating the O button on all timing areas;

FIG. 23 is a drawing to show how the main character A attacks an enemy character A;

FIG. 24 is a drawing to show a screen displayed when the main character A terminates the attack on the enemy character A and returns to the former position;

FIG. 25 is a flowchart to show a procedure of judgment ring determination processing;

FIG. 26 is a drawing to show an arm table;

FIG. 27 is a drawing to show a calculation expression for calculating the damage amount to an enemy character (opposite character damage amount);

FIG. 28 is a drawing to show the display mode of a judgment ring displayed at the command determination time;

FIG. 29 is a drawing to show the display mode of the judgment ring after the command determination;

FIGS. 30A and 30B are drawings to show different examples of 120% areas;

FIG. 31 is a drawing to show a special table;

FIG. 32A is a drawing to show a calculation expression for calculating the opposite character damage amount when attack spell is used and FIG. 32B is a drawing to show a calculation expression for calculating the recovery value when recovery spell is used;

FIG. 33 is a drawing to show an item table;

FIG. 34 is a drawing to show a judgment ring correction parameter table;

FIG. 35 is a flowchart to show a procedure of judgment ring determination processing;

FIG. 36 is a flowchart to show a procedure of main character status change processing;

FIG. 37 is a drawing to show a status table;

FIG. 38 is a drawing to show the “biorhythm” set for a specific main character;

FIG. 39 is a drawing to show the “biorhythm” set for the specific main character;

FIG. 40 is a drawing to show the “biorhythm” set for the specific main character;

FIG. 41 is a drawing to show the “biorhythm” set for the specific main character;

FIG. 42 is a drawing to show the “biorhythm” set for the specific main character;

FIG. 43 is a drawing to show a status screen of the specific main character;

FIG. 44 is a drawing to show a “biorhythm screen of the specific main character; and

FIG. 45 is a drawing to show the configuration of a network game system.

### DETAILED DESCRIPTION OF THE PREFERRED EMBODIMENTS

Referring now to the accompanying drawings, there is shown a preferred embodiment of the invention.

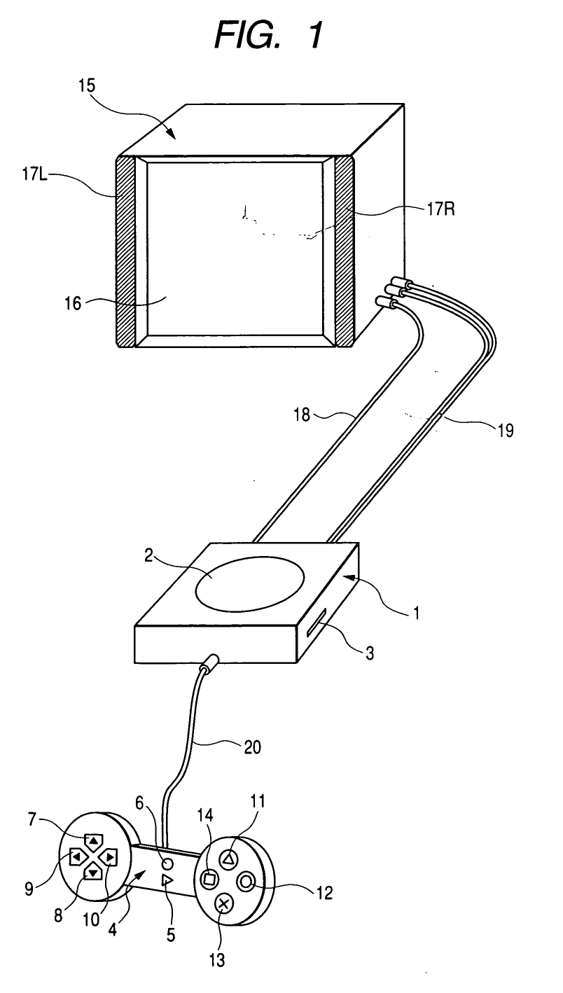

FIG. 1 shows the general configuration of a gaming machine incorporating the invention. The gaming machine includes a main unit 1, a controller 4 as operation unit for outputting a control command to the main unit 1 in response to operation of a player, and a display 15 for displaying an image based on an image signal from the main unit 1. In the gaming machine, a game is executed as various images are displayed on a display surface (screen). 16 of the display 15 such as a CRT.

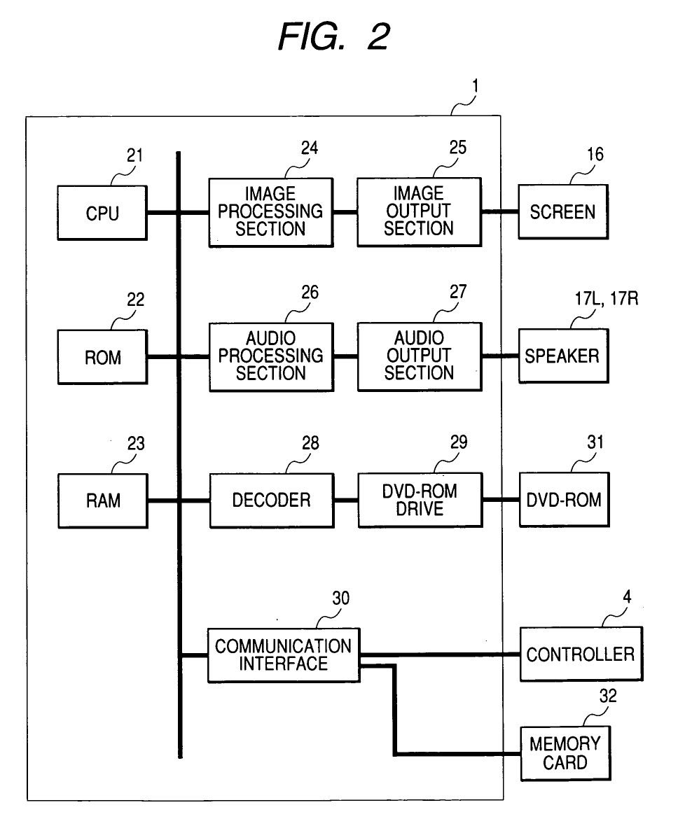

A game executed in the gaming machine is executed as a gaming program recorded on an external record medium separate from the main unit 1 is read. In addition to a CD-ROM or a DVD-ROM, an FD (flexible disk) or any other record medium can be used as the external record medium recording the gaming program. In the embodiment, a DVD-ROM is used as the external record medium. A cover 2 that can be opened and closed is provided in the top center of the main unit 1. As the cover 2 is opened, a DVD-ROM 31 (FIG. 2) can be placed in a DVD-ROM drive 29 (FIG. 2) as a record medium drive provided inside the main unit 1.

The controller 4 includes various input parts for outputting a control command to a CPU 21 (FIG. 2) in the main unit 1 in response to operation of the player. The controller 4 is provided in the left portion with an up button 7, a down button 8, a left button 9, and a right button 10 mainly operated by the player to move a character in a game or move an option of a menu as the input parts. The controller 4 is provided in the right portion with a a button 11, a O button 12, a X button 13, and a □ button 14 mainly operated by the player to determine or cancel various items. The controller 4 is provided in the center with a selection button 6 at the top and a start button 5 at the bottom.

The display 15 has input terminals of a video signal and an audio signal, which are connected to a video output terminal and an audio output terminal of the main unit 1 by terminal cables 18 and 19. Used as the display 15 is an existing television having in one piece the screen 16 that can display image data output from an image output section 25 (FIG. 2) described later and speakers 17L and 17R that can output audio data output from an audio output section 27 (FIG. 2) described later. The main unit 1 and the controller 4 are connected by a signal cable 20 as shown in FIG. 1.

The main unit 1 is provided on one side with a memory slot 3 as an insertion slot of a memory card 32 (FIG. 2). The memory card 32 is a storage medium for temporarily recording game data in a case such as when the player interrupts the game. The data recorded on the memory card 32 is read through a communication interface 30 (FIG. 2) described later having a card reader function.

Electric Configuration

FIG. 2 shows the system configuration of the gaming machine. The main unit 1 includes the CPU 21 as control means, ROM 22 and RAM 23 as storage means, an image processing section 24, the image output section 25, an audio processing section 26, the audio output section 27, a decoder 28, the DVD-ROM drive 29, and the communication interface 30.

The DVD-ROM 31 can be attached to and detached from the DVD-ROM drive 29 and the gaming program in the DVD-ROM 31 placed in the DVD-ROM drive 29 is read by the CPU 21 in accordance with a basic operation program of an OS (operating system), stored in the ROM 22. The read gaming program is converted into predetermined signals by the decoder 28 for storage in the RAM 23.

The gaming program stored in the RAM 23 is executed by the CPU 21 in accordance with the basic operation program or an input signal from the controller 4. Image data and audio data are read from the DVD-ROM 31 in response to the executed gaming program. The image data is sent to the image processing section 24 and the audio data is sent to the audio processing section 26.

The image processing section 24 converts the received image data into an image signal and supplies the image signal to the screen 16 through the image output section 25. The audio processing section 26 converts the received audio data into an audio signal and supplies the audio signal to the speakers 17L and 17R through the audio output section 27.

The communication interface 30 enables the controller 4 and the memory card 32 to be connected detachably to the main unit 1. Through the communication interface 30, data is read from and written into the memory card 32 and a signal from the controller 4 is sent to the sections including the CPU.21.

### SPECIFIC EXAMPLE OF GAME CONTENT

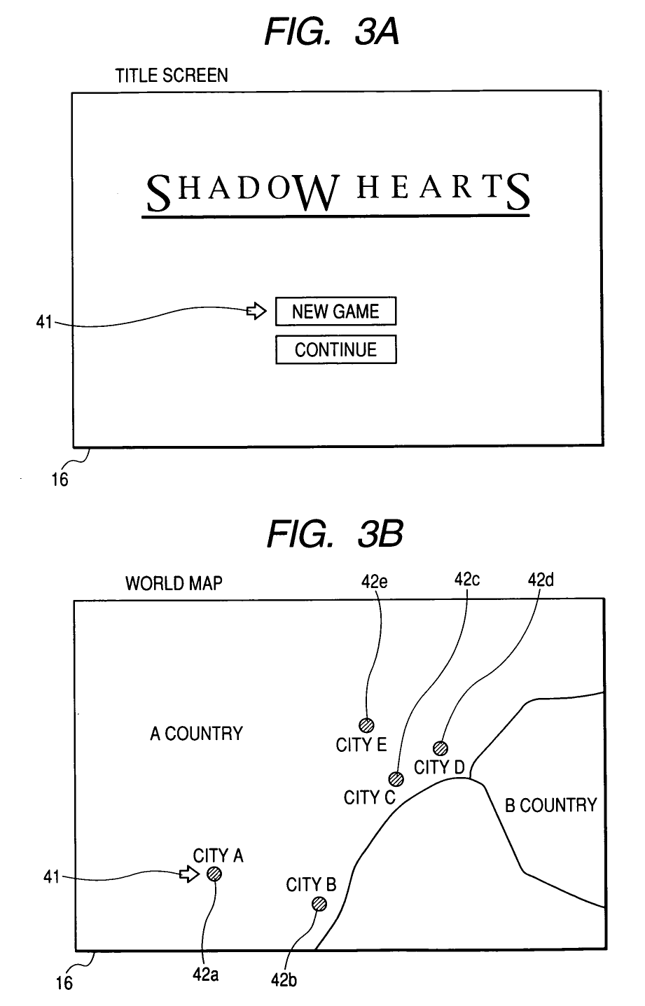

Next, specific examples of processing executed by the CPU 21 based on the gaming program recorded on the DVD-ROM 31 and the game content displayed on the screen 16 as the processing is executed will be discussed. Flows of the game processing executed based on the gaming program according to the invention will be discussed with reference to FIGS. 3A to 44.

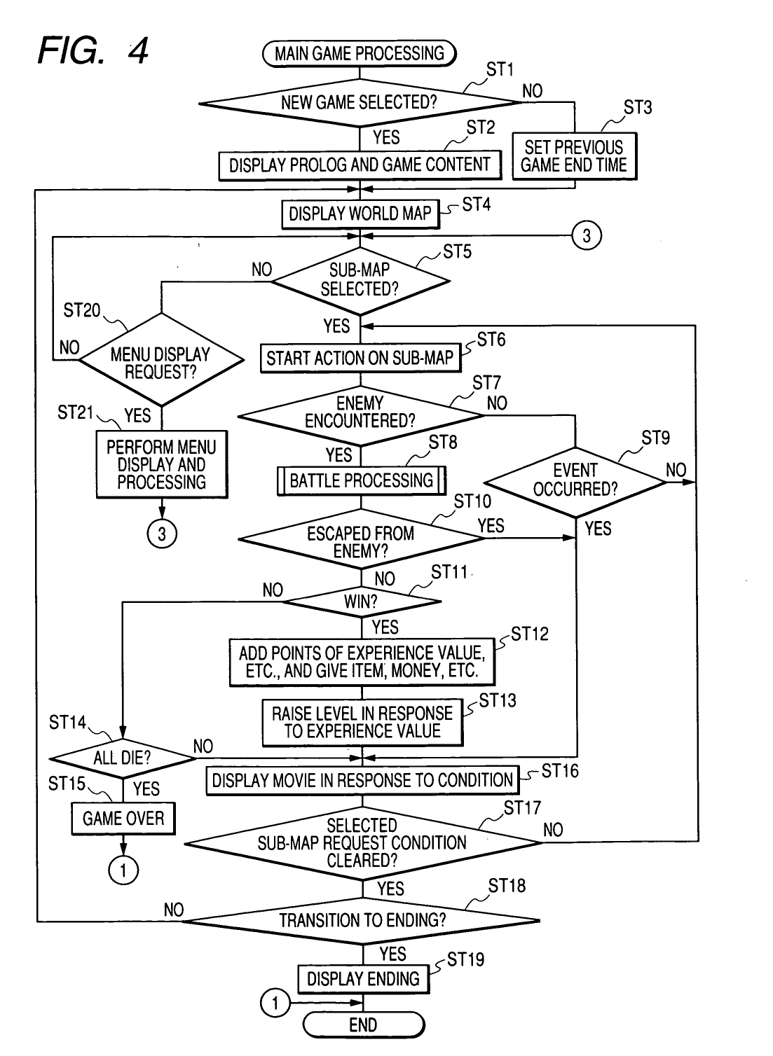

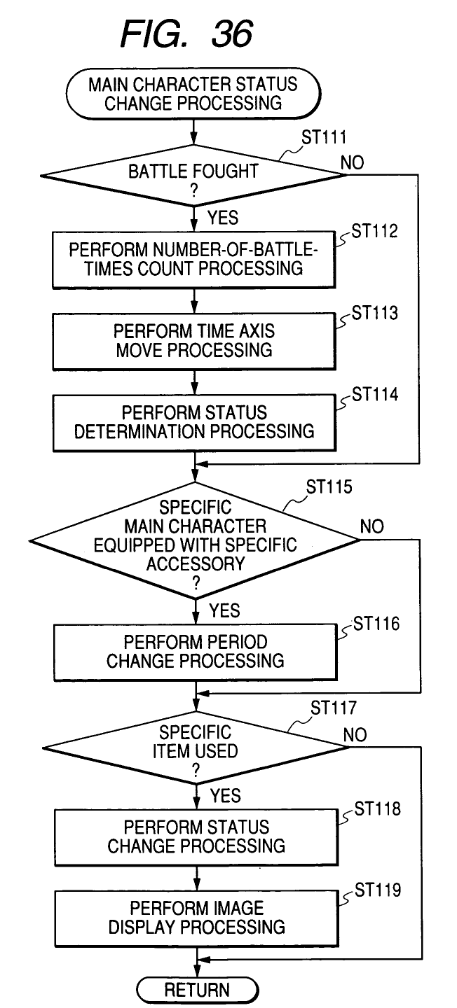

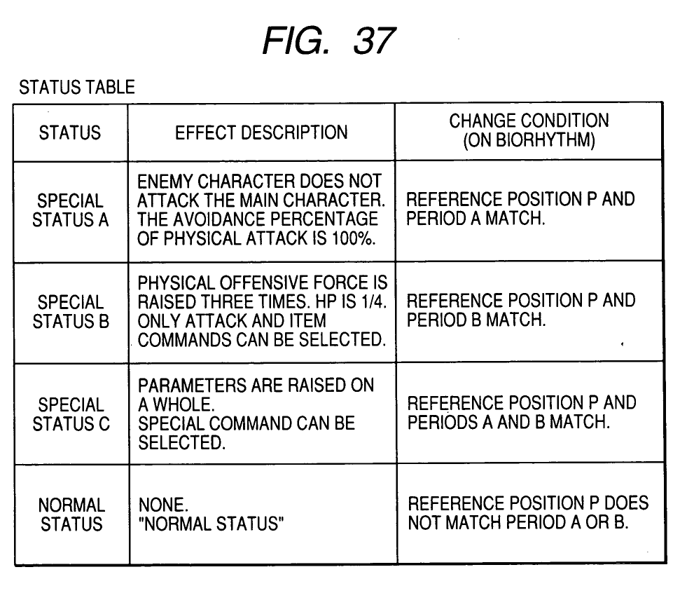

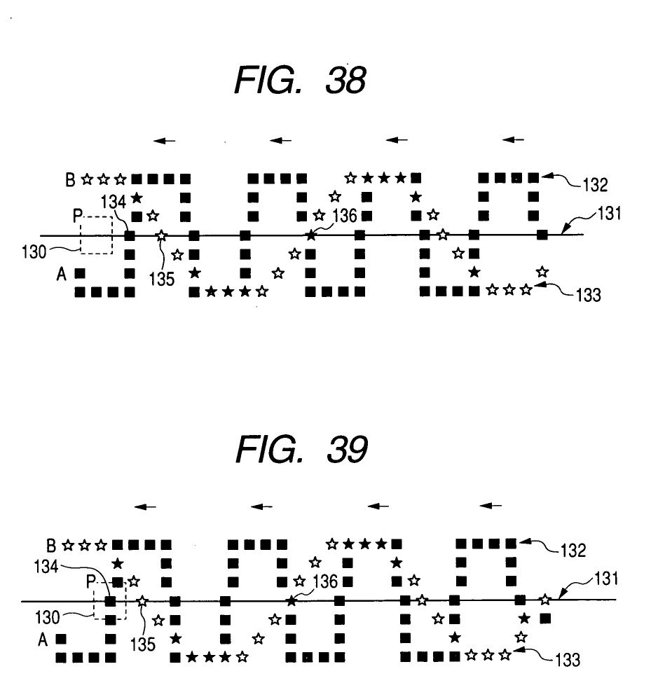

The game processing executed based on the gaming program according to the invention is characterized by the fact that it includes game processing for executing “main character status change processing” for changing the “status” of a specific main character as a predetermined condition is satisfied. The four types of “status” of the specific main character are set: “normal status” and three types of “special status” (“special status A,” “special status B,” and “special status C”). (See FIG. 37.) A different advantage is set for each of the three types of “special status.” The advantage is conducted for the specific main character in a battle scene in which the specific main character making a transition to the “special status” takes part (for example, rise in the attack power or the like). The “status” of the specific main character is controlled so as to change among the four types of “status” by performing change control of “biorhythm” (see FIG. 38) set for the specific main character or the like. Further, the change control of “biorhythm” is performed as a battle is executed between the main character and an enemy character (YES at ST7 in FIG. 4). The “main character status change processing” is described later in detail with FIGS. 36 to 44.

When power of the main unit 1 is on, if the DVD-ROM 31 is placed in the DVD-ROM drive 29, “opening demonstration” is displayed on the screen 16. The “opening demonstration” is effect display for telling the player about the start of a game. After the “opening demonstration” is displayed for a predetermined time, a “title screen” drawing a game title large is displayed and “main game processing” shown in FIG. 4 is started.

Title Screen Description

FIG. 3A shows an example of the “title screen.” Here, the character string of the game title, SHADOW HEARTS, is displayed and two options (NEW GAME and CONTINUE) are displayed below the game title. A cursor 41 is displayed at the left position of the option of either NEW GAME or CONTINUE and as the player operates the up button 7 or the down button 8, the position of the cursor 41 is changed. When the player operates the O button 12, the option pointed to by the cursor 41 is selected.

Main Game Processing

In the “main game processing” shown in FIG. 4, first, which of the two options is selected on the title screen is determined (ST1). If it is determined that NEW GAME is selected (YES at ST1), a prolog and the game content are displayed (ST2) and then a “world map” shown in FIG. 3B is displayed (ST4). On the other hand, if it is determined that CONTINUE is selected (NO at ST1), the situation at the previous game end time is set (game history data recorded on the memory card 32 placed in the memory slot 3 of the main unit 1 is read) at ST3, and the “world map” is displayed without displaying the prolog or the game content at ST4.

As the game according to the embodiment, a main character which acts based on operation of the player and an enemy character which acts based on the gaming program appear and a game developed centering on the battle between the characters is realized on the screen 16. In the embodiment, for example, a plurality of main characters such as main characters A and B appear as the main characters and the game proceeds in the party unit made up of a plurality of main characters. Various types of status are set for each character. The experience value, money, arms, skill, and the like added by the number of gaming times, the number of times an enemy character has been beaten and the like, are defined as the status.

Screen Description of World Map

FIG. 3B shows an example of “world map.” The main cities of “A country” as the stage of the game story are displayed on the “world map” and options indicated by five city names (CITY A 42a, CITY B 42b, CITY C 42c, CITY D 42d, and CITY E 42e) are displayed. They are options to make a transition to a provided “sub-map.” As the player operates the up button 7 or the down button 8, for example, the cursor 41 indicating each option moves and as the player operates the O button 12, one option is selected. When one “sub-map” is thus selected, the “world map” makes a transition to the screen corresponding to the “sub-map” and the player can play various games set in response to the “sub-map.” Specifically, the visual scene in each city is prerender-displayed as a background image conforming to scene development and while the main characters move therein, various events are conquered and the story proceeds.

When the player operates the O button 14 on the “world map,” a “menu screen” is displayed, enabling the player to make various settings on the “menu screen.” For example, the player can make various settings to cause the main character to use “items,” “accessories,” and the like to change the status set for each main character or equip the main character with the “items,” “accessories,” and the like.

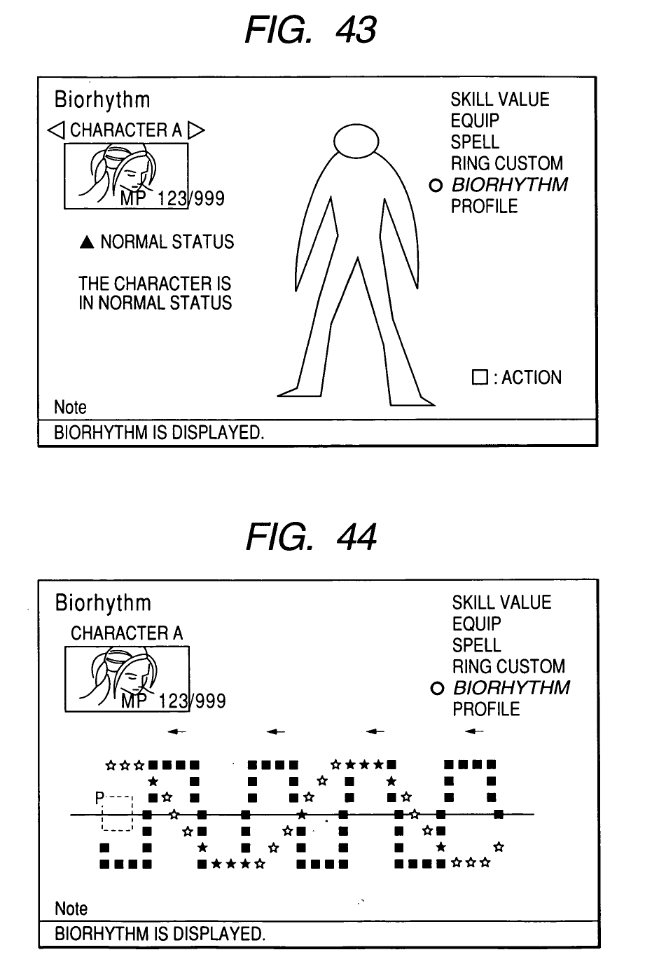

The “menu screen” also enables the player to check “biorhythm” as a trigger for changing the “status” of a specific main character described later to the “special status” and the “status” of the specific main character changed in response to change in the “biorhythm” (see FIGS. 43 and 44).

Main Game Processing

Referring again to FIG. 4, when any of the options displayed on the “world map” is selected (YES at ST5), a start screen of the “sub-map” responsive to the selected option is displayed and the party of the main characters starts action on the “sub-map” (ST6). On the other hand, when the determination at ST5 is NO, whether or not the player operates the O button 14 on the “world map” for making a “menu screen” display request is determined (ST20). When the determination at ST20 is YES, the “menu screen” is displayed and various types of setting processing are performed as various commands, such as ITEM and EQUIP, are entered in response to operation of the player (ST21). The action on the “sub-map” is for the main character to walk, talk to a pedestrian, do shopping, etc. The player can also display the “menu screen” by operating the L button 14 on the “sub-map” and various types of operation mentioned above are made possible. The player can select the ITEM command for changing the status of the skill, etc., of an ally character (for example, recovery) and can select a STATUS command for checking the status of the skill, experience value, etc., set for each main character. For example, the player can select a specific main character for which “biorhythm” is set on the “menu screen,” thereby displaying the current “status” (“normal status” or any of the three types of “special status”) of the specific main character (see FIG. 43). The player can select a BIORHYTHM command, thereby displaying the current status of the “biorhythm” of the specific main character (see FIG. 44).

Then, if the main character party starting action on the “sub-map” encounters an enemy character (YES at ST7), “battle processing” is started (ST8). When the “battle processing” is started, a transition is made to a “battle scene” where a battle is fought between the main character party and the enemy character. The “battle processing” is described later. On the other hand, if the main character party does not encounter an enemy character (NO at ST7), when some event occurs (YES at ST9), the process proceeds to ST16 and a movie responsive to the event is displayed; when no event occurs (NO at ST9), the process returns to ST6.

IN the “battle scene” executed by performing the “battle processing,” if the main character party succeeds in escaping from the enemy character (YES at ST10), the process proceeds to ST16 and a movie responsive to the situation is displayed. On the other hand, if the main character party fails in escaping from the enemy character or the main character party fights a battle with the enemy character (NO at ST10), subsequently whether or not the main character party wins the enemy character in the battle in the “battle scene” is determined (ST11). When the determination is YES, namely, when the main character party wins the enemy character, points of the experience value, etc., are added and an item and money are given to each character of the party in response to the type of enemy character and the battle substance (ST12). The level of each character is raised in response to the experience value of the character (ST13). Then, a movie responsive to the situation is displayed (ST16). When the determination at ST11 is NO, namely, when the main character party cannot win the enemy character, subsequently whether all characters of the main character party die is determined (ST14). When the determination is NO, it is determined that such an event for terminating the battle is caused to occur. The process proceeds to ST16 and a movie responsive to the situation is displayed. When the determination at ST14 is YES, the game is over (ST15) and the main game processing is terminated.

After a movie is displayed at ST16, whether or not the selected sub-map request condition has been cleared is determined (ST17). When the sub-map request condition has been cleared (YES at ST17), the process proceeds to ST18 and whether or not a transition is to be made to the ending is determined. If the sub-map request condition is not cleared (NO at ST17), the process proceeds to ST6. If the determination at ST18 is YES, a predetermined ending is displayed (ST19) and the “main game processing” is terminated. If the determination at ST18 is NO, the process proceeds to ST4.

Battle Processing

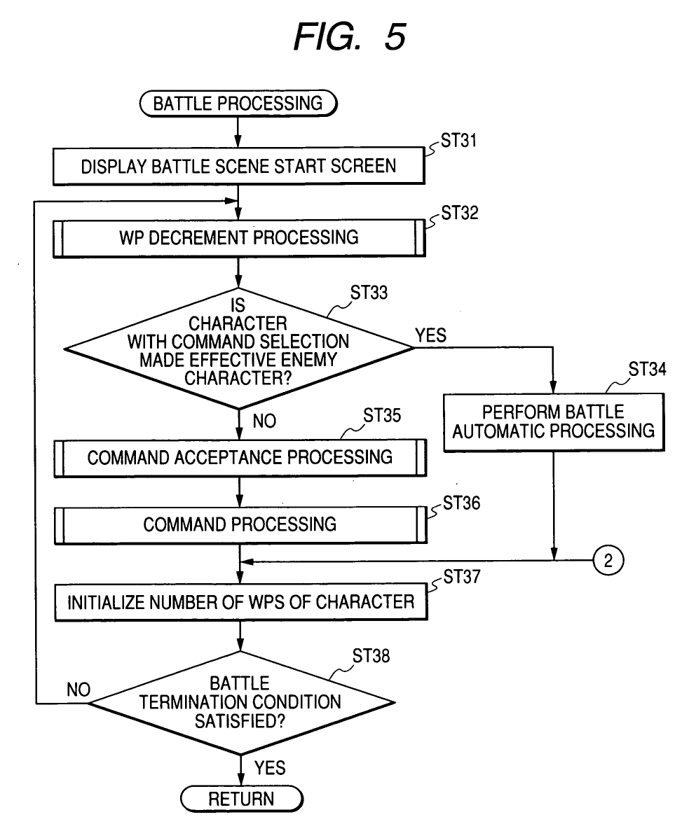

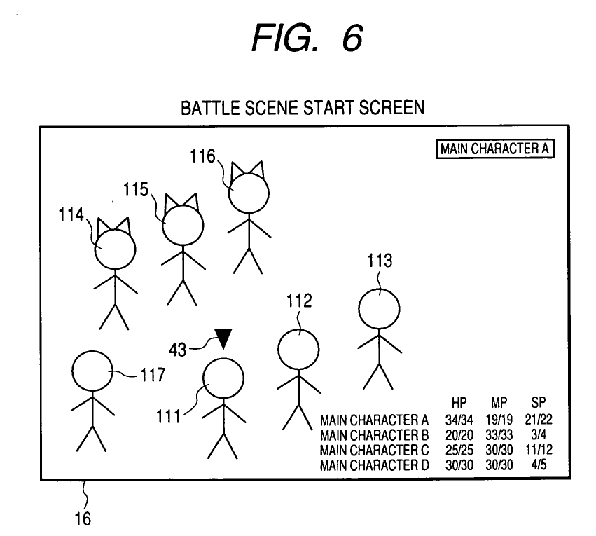

FIG. 5 shows a procedure of the “battle processing” at ST8 in FIG. 4. First, a “battle scene” start screen as shown in FIG. 6 is displayed (ST31). On the “battle scene” start screen as shown in FIG. 6, for example, the main character party (main character A 111, main character B 112, main character C 113, and main character D 117) are displayed toward the player and three enemy characters (enemy character A 114, enemy character B 115, and enemy character C 116) are displayed facing the main character party. Information concerning the status of each main character is displayed in the lower right portion of the start screen. Specifically, hit points (HP), magic points (MP), and sanity points (SP) are predetermined for each main character, and the remaining numbers of points (current number of points/initial number of points) are displayed on the start screen. As HP remains, the main character can execute various commands such as attack, and use item, and when HP becomes zero, the corresponding main character becomes inactive. MP enables the corresponding main character to use a special skill of magic (spell), etc., and when MP becomes zero, the main character becomes unable to use the special skill. SP enables the corresponding main character to hold its sanity. When SP becomes zero, the main character loses its sanity and enters an abnormal status. When the main character enters the abnormal status, command manipulation for the main character becomes ineffective and the main character runs away so as to take abnormal action in such a manner that it makes an attack on any character regardless of whether the character is an enemy or an ally. In the “battle scene,” if a specific main character for which “biorhythm” is set (described later) takes part in the battle, a character image responsive to the “status” of the specific main character is displayed.

Next, “WP decrement processing” to decrement wait points (WP) for managing the order in which the main characters and enemy characters can take action such as an attack based on a predetermined condition is performed (ST32). In the WP decrement processing,” as for the main characters, the action order of the characters to make command selection of the player effective is managed. The “WP decrement processing” is described later in detail.

Whether or not the character for which command selection is made effective in the “WP decrement processing” (the character whose turn has come around) is an enemy character is determined (ST33). If the determination at ST33 is YES, automatic processing is performed in accordance with the gaming program so that the enemy character makes an attack on the main character (ST34), and the process proceeds to ST37.

On the other hand, if it is determined at ST33 that the character for which command selection is made effective is the main character, subsequently “command acceptance processing” of accepting command selection of the player is performed (ST35). The “command acceptance processing” is described later in detail.

Next, the command selection of the player accepted in the “command acceptance processing” is checked and “command processing” for executing display processing responsive to the command type is performed (ST36). As the “command processing” is performed, display processing conforming to the action mode of the selected main character is executed. For example, if an attack command (FIGHT command described later) is selected, display processing such that an attack is made on the enemy character is executed. If a command using a special skill (SPECIAL command described later) is selected, display processing such that a spell attack is made on the enemy character or that recovery spell is used for the attacked ally for recovery is executed. In the “command processing,” “judgment processing” for making possible technical intervention according to the operation timing of the player is also performed. The “command processing” is described later in detail.

After execution of the “command processing,” WP of the character for which command selection is made effective in the “WP decrement processing” is initialized to the initial value 255 (ST37). Subsequently, whether or not the “battle processing” termination condition is satisfied is determined (ST38). When the determination at ST38 is NO, the process returns to ST32; when the determination is YES, the “battle processing” is exited and the process returns to ST10 in FIG. 4. The “battle processing” exit condition is any of the fact that the enemy characters appearing on the battle screen suffer a crushing defeat, the fact that the player selects an “ESCAPE” command and the main character party succeeds in escaping from the enemy characters, the fact that the main character party suffers a crushing defeat, or the fact that such an event for terminating the battle occurs.

WP Decrement Processing

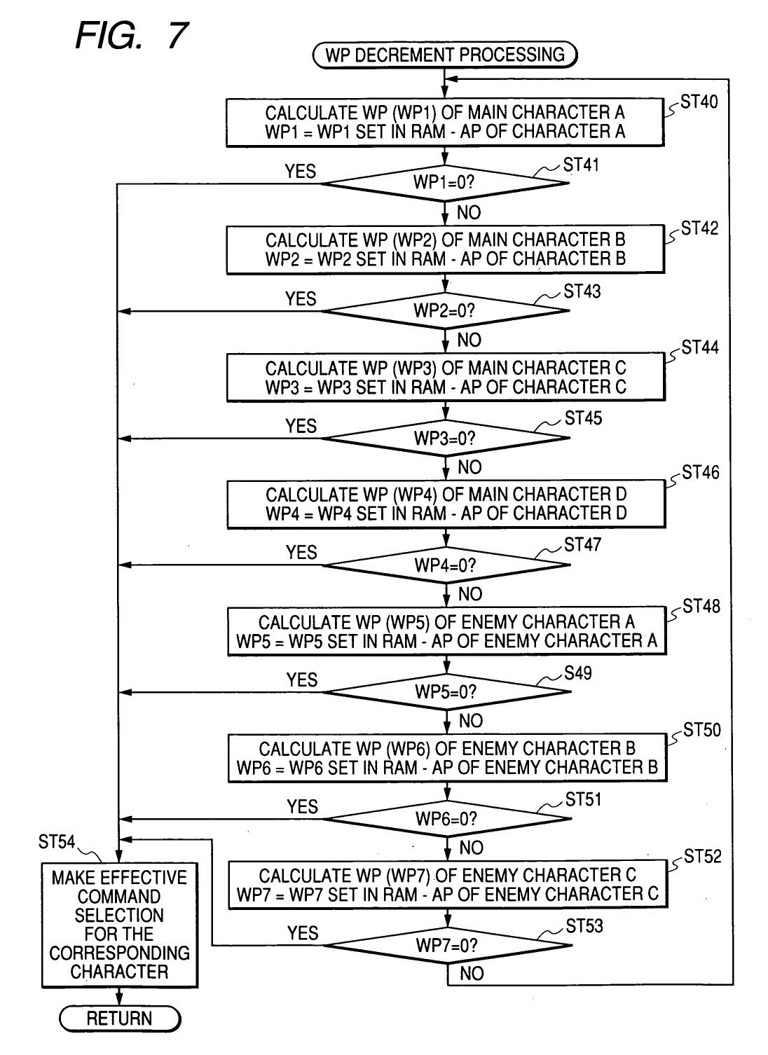

FIG. 7 shows a procedure of the “WP decrement processing” at ST32 in the “battle processing.” First, WP of the main character A (WP of the main character A is represented as WP₁) is calculated and is set in a predetermined area of the RAM 23 (ST40). The initial value of WP is set to 255 and WP1 is calculated by subtracting skill value AP (Action Point) set for the main character A from the value of WP₁ set in the RAM 23 in the previous “WP decrement processing.” The WP calculation method is also applied to other characters in a similar manner and the skill value AP varies from one character to another. For each character, various character individual skills are preset in response to the character level (LV) determined by the experience value, and the skill value AP is calculated based on the status (described later).

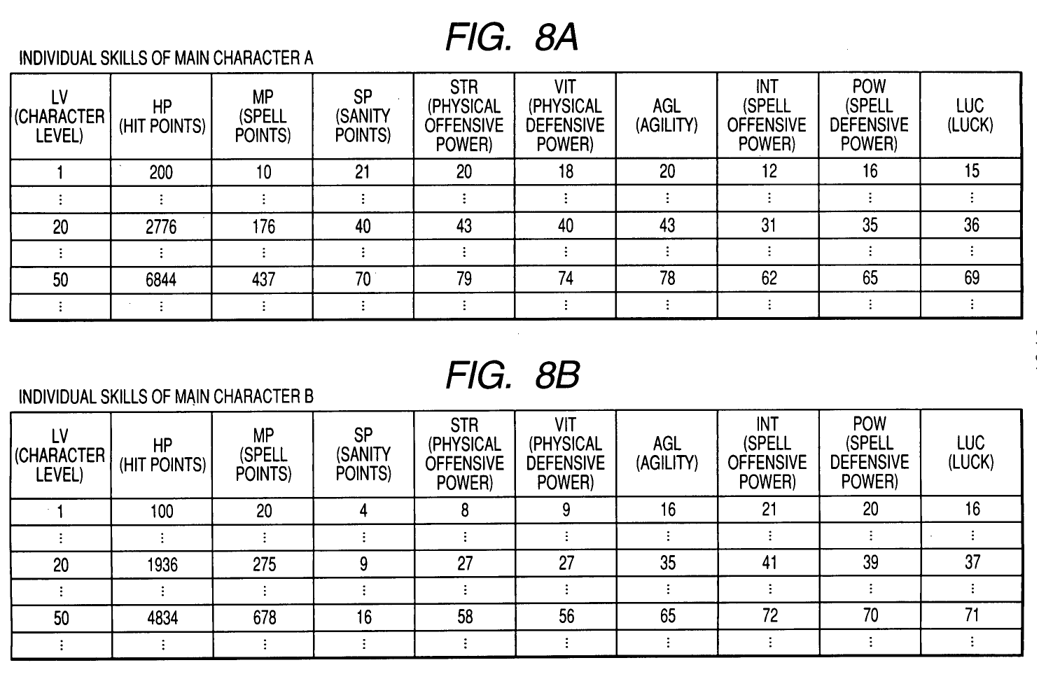

An example will be discussed with FIGS. 8A and 8B. FIGS. 8A and 8B respectively show the character individual skills of the main characters A and B. As shown in FIGS. 8A and 8B, for each character, various character individual skills are preset in response to the character level (LV) varying depending on the experience value. The types of character individual skills include physical attack power (STR), physical defence power (VIT), agility (AGL), spell attack power (INT), spell defence power (POW), and luck (LUC) in addition to HP, MP, and SP described above. Each of them is represented by a numeric value and a different value is set depending on the type of character although the character level is the same. AP is calculated based on AGL and LUC. Specifically, by a calculating formula of AP=AGL+LUC/2.

After WP₁ of the main character A is found at ST40 as described above, subsequently whether or not found WP₁ is 0 is determined (ST41). When the determination at ST41 is YES, command selection for the main character A is made effective (ST54). Therefore, the player can make command specification for commanding the main character A to take action such as an attack.

When the determination at ST41 is NO, WP of the main character B (WP of the main character B is represented as WP₂) is calculated and is set in a predetermined area of the RAM 23 (ST42). Subsequently, whether or not found WP₂ is 0 is determined (ST43). When the determination at ST43 is YES, command selection for the main character B is made effective (ST54). When the determination at ST43 is NO, the process proceeds to ST44.

At ST44, WP of the main character C (WP of the main character C is represented as WP₃) is calculated and is set in a predetermined area of the RAM 23. Subsequently, whether or not found WP₃ is 0 is determined (ST45). When the determination at ST45 is YES, command selection for the main character C is made effective (ST54). When the determination at ST45 is NO, the process proceeds to ST46.

At ST46, WP of the main character D (WP of-the main character D is represented as WP₄) is calculated and is set in a predetermined area of the RAM 23. Subsequently, whether or not found WP₄ is 0 is determined (ST47). When the determination at ST47 is YES, command selection for the main character D is made effective (ST54). When the determination at ST47 is NO, the process proceeds to ST48.

At ST48, WP of the enemy character A (WP of the enemy character A is represented as WP₅) is calculated and is set in a predetermined area of the RAM 23. Subsequently, whether or not found WP₅ is 0 is determined (ST49). When the determination at ST49 is YES, command selection for the enemy character A is made effective (ST54). When the determination at ST49 is NO, the process proceeds to ST50.

At ST50, WP of the enemy character B (WP of the enemy character B is represented as WP₆) is calculated and is set in a predetermined area of the RAM 23. Subsequently, whether or not found WP₆ is 0 is determined (ST51). When the determination at ST51 is YES, command selection for the enemy character B is made effective (ST54). When the determination at ST51 is NO, the process proceeds to ST52.

At ST52, WP of the enemy character C (WP of the enemy character C is represented as WP₇) is calculated and is set in a predetermined area of the RAM 23. Subsequently, whether or not found WP₇ is 0 is determined (ST53). When the determination at ST53 is YES, command selection for the enemy character C is made effective (ST54), the “WP decrement processing” is exited, and the process returns to ST33 in FIG. 5. When the determination at ST53 is NO, the process returns to ST40 and the “WP decrement processing” is again performed from the beginning.

Command Selection Screen

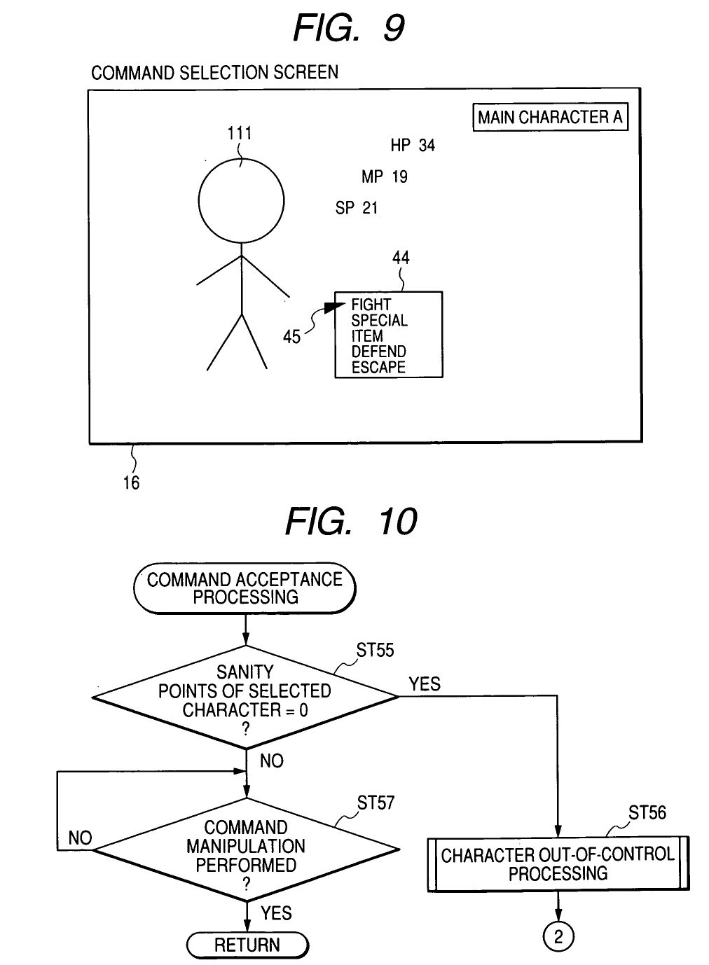

When the character for which command selection is made effective is the main character in the “WP decrement processing,” a selection mark 43 is displayed above the head of the main character for which command selection is made effective on the screen 16, as shown in FIG. 6. After the display, subsequently the main character with the selection mark 43 displayed above the head (in this case, the main character A 111) is zoomed up, and a “command selection screen” as shown in FIG. 9 is displayed.

The “command selection screen” shown in FIG. 9 displays a command menu 44 containing options of commands to determine the action mode of the main character A 111. When the player moves a cursor 45 displayed at the left of the command menu 44 by operating the up button 7 or the down button 8 and operates the O button 12, the command with the cursor 45 displayed at the left position is selected and the action mode of the main character A 111 is determined. In FIG. 9, five commands of FIGHT, SPECIAL, ITEM, DEFEND, and ESCAPE are displayed on the command menu 44. Here, the cursor 45 is displayed at the left position of the FIGHT command and the FIGHT command is selected. The values of HP, MP, and SP of the main character A 111 are displayed above the command menu 44.

Command Acceptance Processing

FIG. 10 shows a procedure of the “command acceptance processing” at ST35 in the “battle processing” shown in FIG. 5. First, when the character for which command selection is made effective in the “WP decrement processing” is the main character, whether or not SP of the main character is 0 is determined (ST55) If the determination at ST55 is YES, “character out-of-control processing” is performed for the main character (ST56) and the process proceeds to ST37 in FIG. 5. If the “character out-of-control processing” is executed, command manipulation for the main character becomes ineffective and the main character runs away so as to take abnormal action in such a manner that it makes an attack on any character regardless of whether the character is an enemy or an ally. On the other hand, when the determination at ST55 is NO, whether or not the player performs command manipulation, namely, selects a command on the “command selection screen” is determined (ST57). If the determination at ST57 is NO, ST57 is repeated. If the determination at ST57 is YES, the “command acceptance processing” is exited and the process returns to ST36 in FIG. 5.

Character Out-of-Control Processing

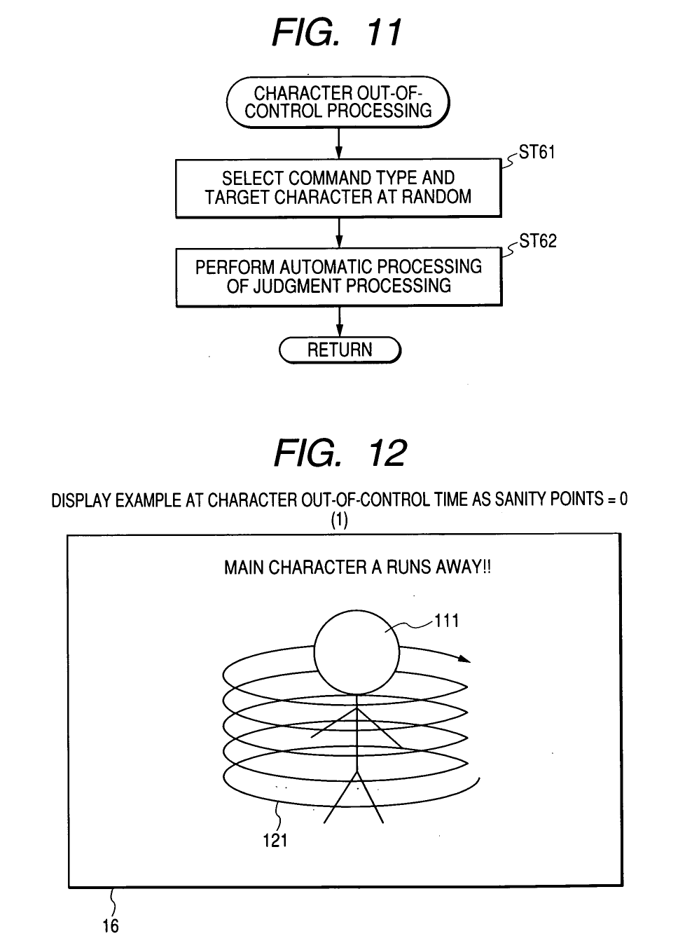

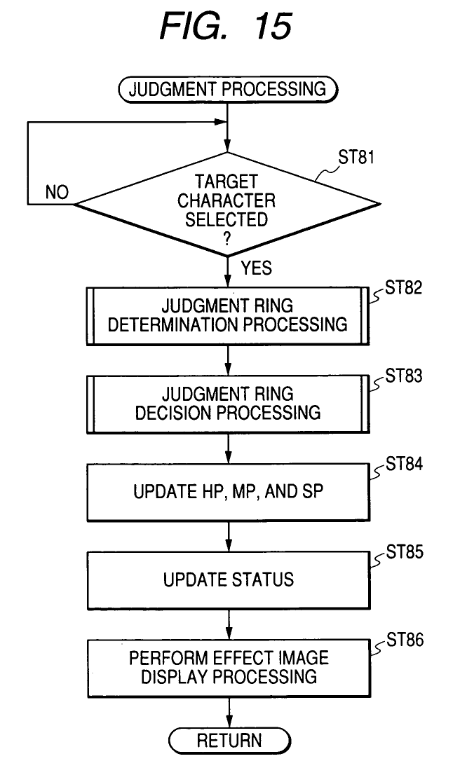

FIG. 11 shows a procedure of the “character out-of-control processing” at ST56 in the “command acceptance processing” in FIG. 10. First, the type of command for determining the action mode of the main character is selected at random and a character to which the action based on the command (such as attack, use of attack spell, use of recovery spell) is applied is selected at random regardless of whether the character is an enemy or an ally (ST61). For example, if the FIGHT command is selected, a character to be attacked is selected at random regardless of whether the character is an enemy or an ally. Automatic processing of “judgment processing” in FIG. 15 for displaying the operation of the character determined based on the selected command, etc., is performed (ST62) and the “character out-of-control processing” is exited.

### DISPLAY EXAMPLES OF CHARACTER OUT-OF-CONTROL PROCESSING

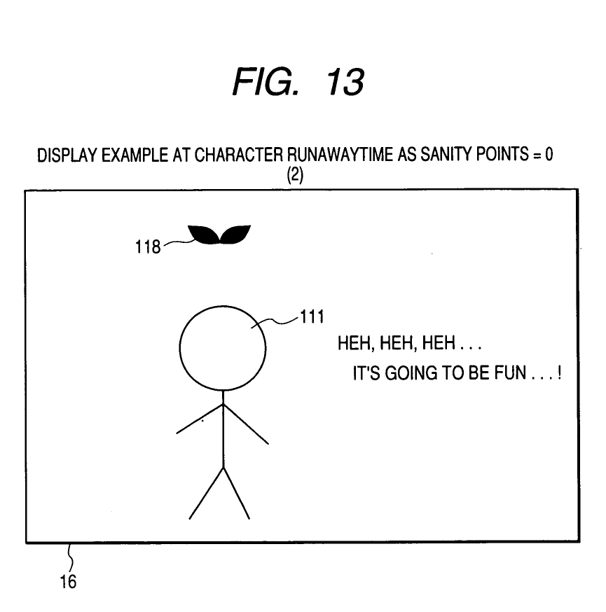

FIGS. 12 and 13 show specific display examples when “character out-of-control processing” is executed; the figures show display examples when SP of the main character A 111 becomes 0 and the “character out-of-control processing” is executed for the main character A 111.

FIG. 12 shows the display mode just after execution of the “character out-of-control processing” is started, displaying how black smoke 121 rises from the legs of the main character A 111 and surrounds the body of the main character A 111. At this time, a character string of “main character A runs away!!” is also displayed on the screen 16. Then, a out-of-control mark 118 indicating that the main character A 111 runs away is displayed above the head of the main character A 111 and, for example, a character string of “heh, heh, heh . . . it's going to be fun . . . !” is also displayed, as shown in FIG. 13. Then, the main character A 111 takes action such as an attack on the target character selected at ST61 in FIG. 11.

In the embodiment, once the out-of-control state is entered, no commands are accepted; however, only some commands may be accepted on a predetermined condition. For example, although only the ITEM command is accepted, which character the selected “item” is to be used for is unknown or one FIGHT command is accepted every three turns. The main character runs away when SP=0 and the character may be restored to the normal state after the expiration of a time interval rather than continuing to out-of-control.

Command Processing

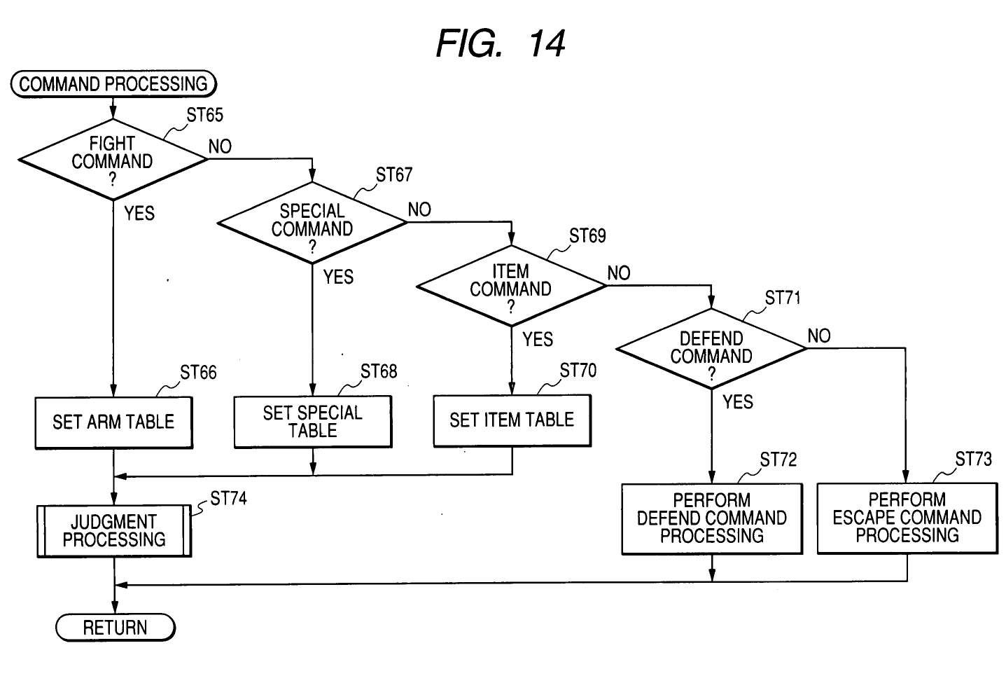

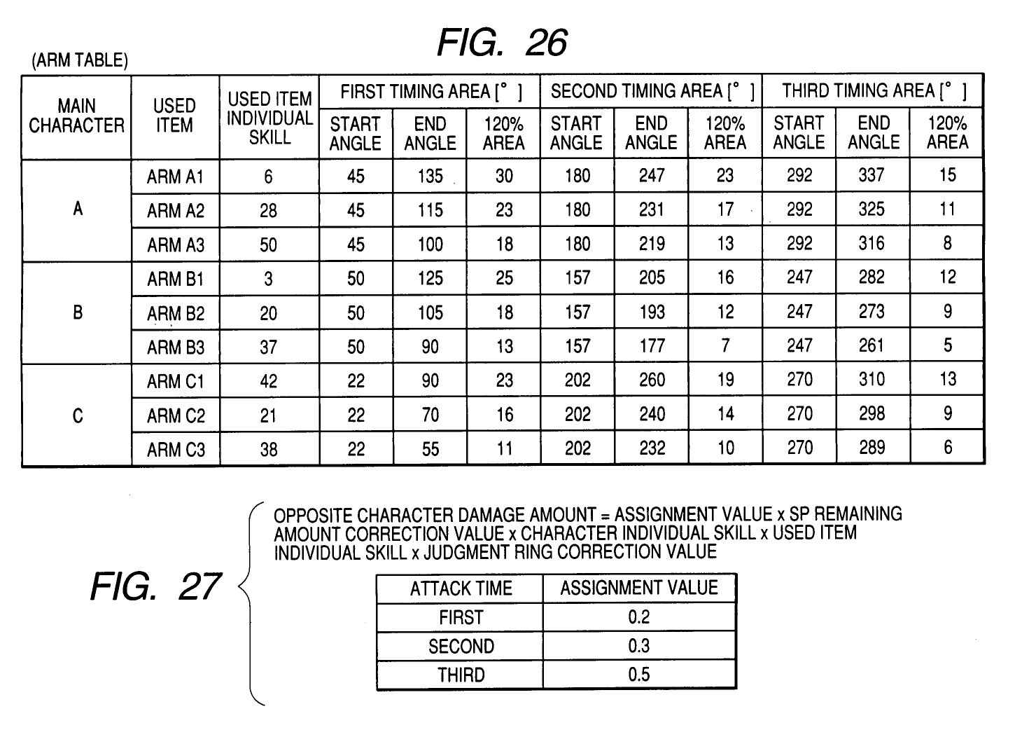

FIG. 14 shows a procedure of the “command processing” at ST37 in the “battle processing” in FIG. 5. First, whether the selected command is the FIGHT command is determined (ST65). When the determination at ST65 is YES, namely, when the player selects the option FIGHT on the “command selection screen” in FIG. 9, an “arm table” (shown in detail in FIG. 26) is fetched from the DVD-ROM 31 and is set in a predetermined area of the RAM 23 (ST66)

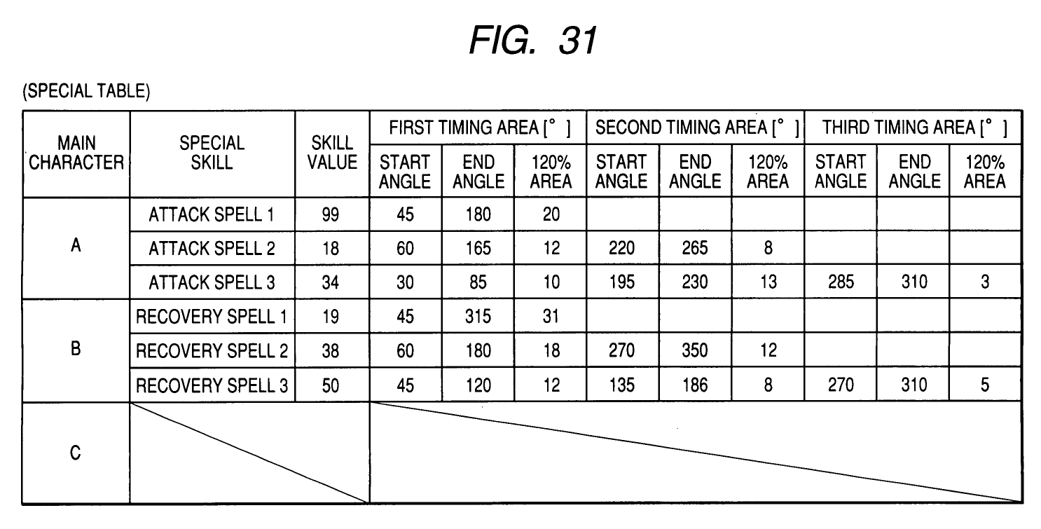

When the determination at ST65 is NO, whether the selected command is the SPECIAL command, namely, whether or not the player selects the option SPECIAL on the “command selection screen” in FIG. 9 is determined (ST67). When the determination at ST67 is YES, a “special table” (shown in detail in FIG. 31) is fetched from the DVD-ROM 31 and is set in a predetermined area of the RAM 23 (ST68).

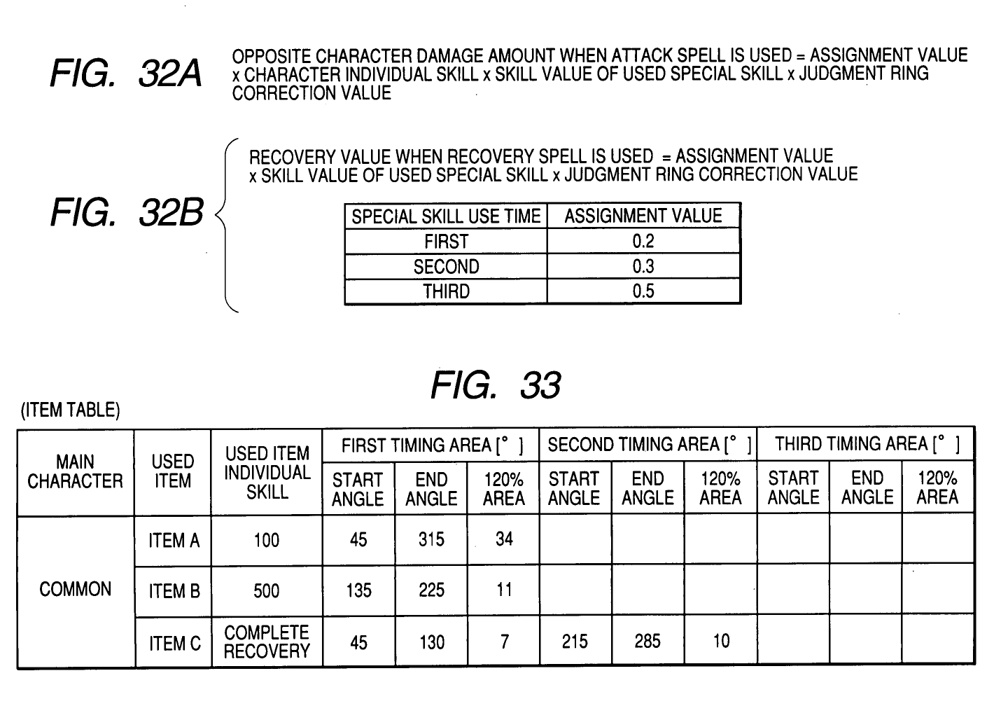

When the determination at ST67 is NO, whether the selected command is the ITEM command, namely, whether or not the player selects the-option ITEM on the “command selection screen” in FIG. 9 is determined (ST69). When the determination at ST69 is YES, an “item table” (shown in detail in FIG. 33) is fetched from the DVD-ROM 31 and is set in a predetermined area of the RAM 23 (ST70)

When the determination at ST69 is NO, whether the selected command is the DEFEND command, namely, whether or not the player selects the option DEFEND on the “command selection screen” in FIG. 9 is determined (ST71). When the determination at ST71 is YES, DEFEND command processing for displaying how the main character defends from the attack of the enemy character is executed (ST72), the “command processing” is exited, and the process returns to ST37 in FIG. 5.

When the determination at ST71 is NO, ESCAPE command processing for displaying how the main character escapes from the enemy character is executed (ST73), the “command processing” is exited, and the process returns to ST37 in FIG. 5.

When the player selects any of the FIGHT command, the SPECIAL command, or the ITEM command and the table corresponding to the selected command is set in the predetermined area of the RAM 23, “judgment processing” for displaying the operation of the main character determined based on the command and the table is executed (ST74), the “command processing” is exited, and the process returns to ST37 in FIG. 5.

Judgment Processing

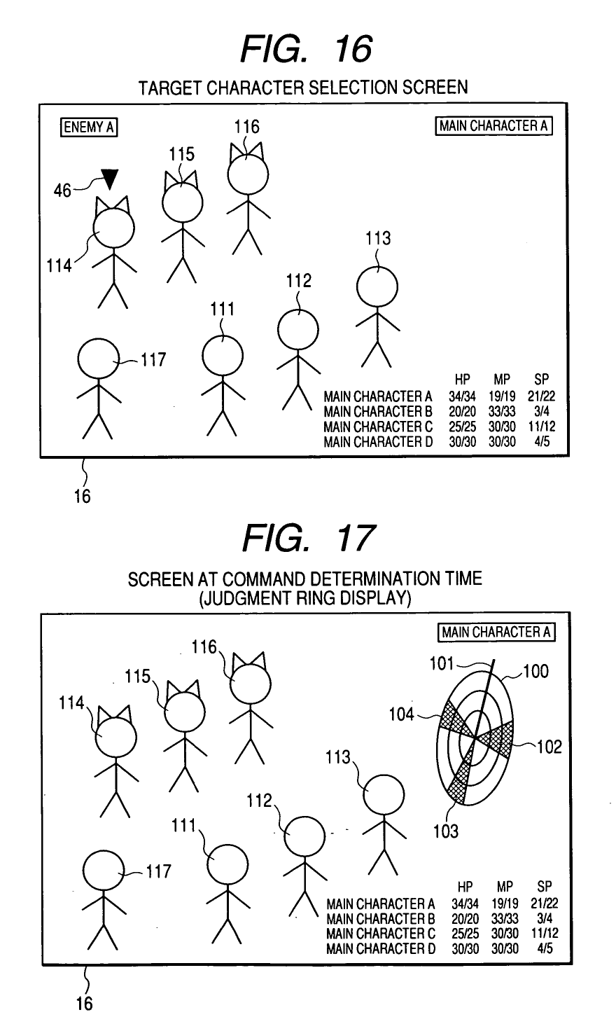

FIG. 15 shows a procedure of the “judgment processing.” First, whether or not the player selects a target character to which the action taken based-on the selected command (attack, use of attack spell, use of recovery spell, etc.,) is applied is determined (ST81). Specifically, upon completion of command selection on the “command selection screen” in FIG. 9, a “target character selection screen” as shown in FIG. 16 is displayed and the player selects the target character on the screen. The target character is selected as follows: A selection mark 46 displayed on the “target character selection screen” is moved as the player operates the up button 7 or the down button 8. When the player operates the O button 12, the character with the selection mark 46 displayed above the head is determined to be the target character. FIG. 16 shows the case where the selection mark 46 is displayed above the head of the enemy character A 114 and the enemy character is determined to be the target character. Not only an enemy character, but also an ally character may be determined the target character.

When the determination at ST81 is YES, “judgment ring determination processing” is executed (ST82) and subsequently “judgment ring determination processing” is executed (ST83). The “judgment ring determination processing” and the “judgment ring determination processing” are described later.

Subsequently, the values of HP, MP, and SP are updated based on the damage amount or the recovery value calculated in the “judgment ring determination processing” at ST83 (ST84). Here, HP and MP are incremented or decremented and SP is decremented in response to the damage amount, the recovery value, etc. SP is decremented by one each time ST84 is executed. That is, it is decremented by one every turn of the character.

Next, the status of the character is updated in response to the determinations made at ST82 and ST83 (ST85). At ST85, if the status of the character is updated to the “abnormal status,” the character enters the abnormal status different from the normal status. The “abnormal status” varies depending on the type of attack item, spell, etc. For example, “poison” abnormal status is an abnormal status in which the physical strength of the character is automatically decreased every turn for the main character to take action upon reception of spell from the enemy or upon reception of attack of a predetermined item. “petrifaction” abnormal status is an abnormal status in which the character is frozen like a stone and it becomes impossible to enter a command upon reception of spell from the enemy or upon reception of attack of a predetermined item.

Effect image display processing for the main character to take predetermined action (such as attack and use spell) against the target character is executed based on the updated parameters (ST86), the “judgment processing” is exited, and the process returns to ST37 in FIG. 5.

In the game according to the invention, just before the main character takes action against the target character based on the selected command, a judgment ring 100 as a variable display area is displayed as shown in FIG. 17 and the necessary parameters for determining the advantage are determined using the judgment ring 100.

As shown in FIG. 17, the judgment ring 100 is displayed in a state in which it is inclined in a slanting direction. Displayed on the judgment ring 100 is a rotation bar 101 as a varying area for clockwise rotating like a clock hand with the center point of the judgment ring 100 as a support. Also displayed on the judgment ring 100 are timing areas colored in predetermined angle ranges, which will be hereinafter referred to as timing areas. The timing areas are “effective areas” relatively advantageous to the player.

Then, the settings of the parameters are changed depending on whether or not the player can operate the O button 12 when rotation of the rotation bar 101 is started and the rotation bar 101 passes through any of the timing areas. The timing areas include three timing areas as shown in FIG. 17. The timing area through which the rotation bar 101 first passes is a “first timing area” 102, the timing area through which the rotation bar 101 next passes is a “second timing area” 103, and the timing area through which the rotation bar 101 last passes is a “third timing area” 104.

For example, when the player can well operate the O button 12 on any of the three timing areas, namely, the player can operate the O button 12 with the rotation bar 101 on any of the three timing areas, then the action taken by the main character against the enemy character becomes effective. If the FIGHT command is selected, three attacks are made on the enemy character to cause damage thereto by predetermined attack power. If the SPECIAL command is selected and recovery spell is used, spell having predetermined recovery power can be worked on an ally character three times for giving recovery power to the ally character.

In contrast, if the player upsets the operation timing of the O button 12 on one timing area, the advantage assigned to the timing area becomes ineffective. Particularly, if the player fails three times, the advantage becomes zero. In the embodiment, the player visually recognizes the effective areas of the judgment ring 100; the point is that the five senses of the player may be influenced to enable the player to recognize the operation timing. For example, it is also possible to adopt an auditory configuration wherein specific voice (sound) is generated for a predetermined time and the player is requested to operate in the generation section or a tactile configuration wherein the controller 4 or a portable terminal is vibrated and the player is requested to operate in the vibration generation section.

FIG. 18 shows a screen displayed when the O button 12 is operated when the rotation bar 101 passes through the first timing area 102. As shown in FIG. 18, if the player can well operate the O button 12 on the first timing area 102, a character string of COOL is displayed, for example.

FIG. 19 shows a screen displayed when the O button 12 is operated when the rotation bar 101 passes through the second timing area 103. As shown in FIG. 19, if the player can well operate the O button 12 on the second timing area 103, a character string of GOOD is displayed, for example.

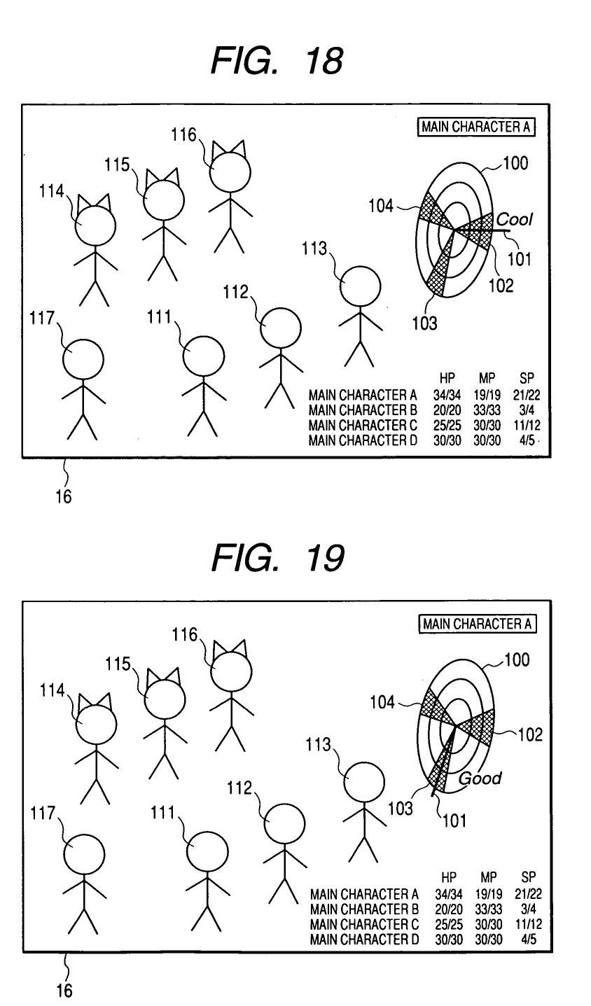

FIG. 20 shows a screen displayed when the O button 12 is operated when the rotation bar 101 passes through the third timing area 104. As shown in FIG. 20, if the player can well operate the O button 12 on the third timing area 104, a character string of PERFECT is displayed, for example.

FIG. 21 shows a screen displayed when the O button 12 is operated before the rotation bar 101 enters the first timing area 102, namely, when the player fails in operating the O button 12 on the timing area. As shown in FIG. 21, if the player fails in operating the O button 12 on the timing area, a character string of MISS is displayed, for example.

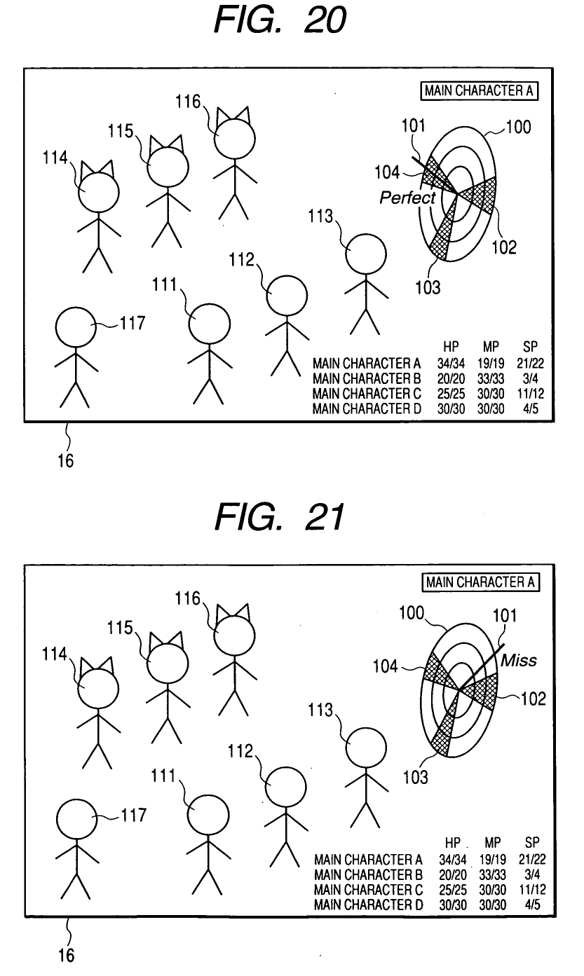

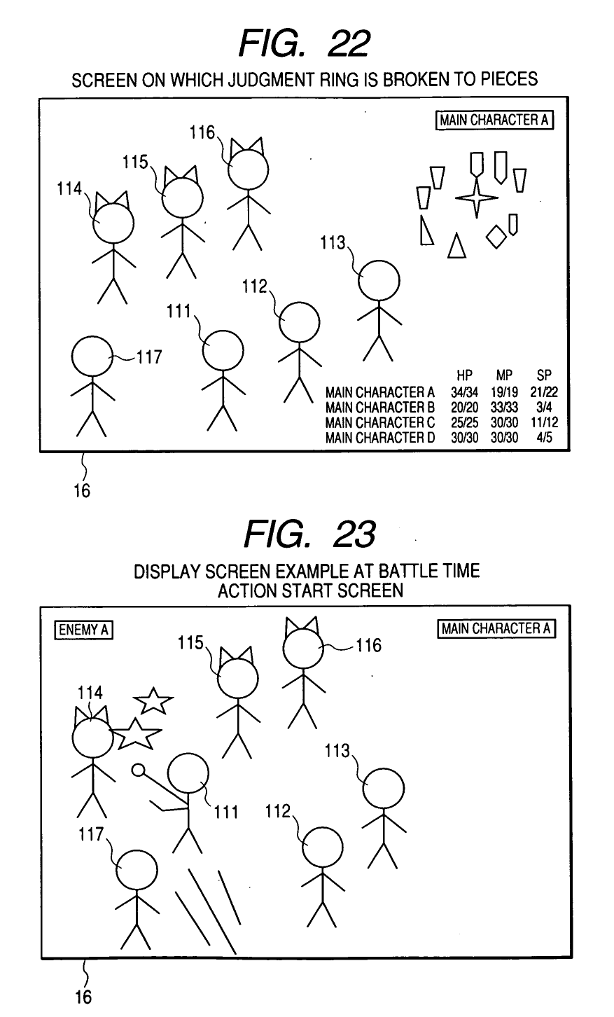

FIG. 22 shows a screen displayed after rotation of the rotation bar 101 stops when the player can well operate the O button 12 on the three timing areas, namely, when the player can operate the O button 12 when the rotation bar 101 exists on the three timing areas. As shown in FIG. 22, the judgment ring 100 is broken to pieces and the pieces scatter at the same time as rotation of the rotation bar 101 stops. Then, the main character A 111 with the FIGHT command selected in FIG. 9 moves to the enemy character A 114 selected as the target character in FIG. 16 and attacks the enemy character. The attack power at this time (damage amount to enemy character) varies depending on the operation timing of the O button 12 in the judgment ring 100.

FIG. 23 shows how the main character A 111 takes action against the enemy character A 114 based on the selected command and the operation result during display of the judgment ring 100. Here, the FIGHT command is selected and the main character A 111 attacks the enemy character A 114. When the-player can well operate the O button 12 on the three timing areas during display of the judgment ring 100, the main character A 111 makes three attacks on the enemy character A 114 by predetermined attack power on the screen, as described above.

In the embodiment, if the player fails the first operation, he or she can give a challenge to the second operation, but when the player fails the first operation, operation acceptance may be terminated.

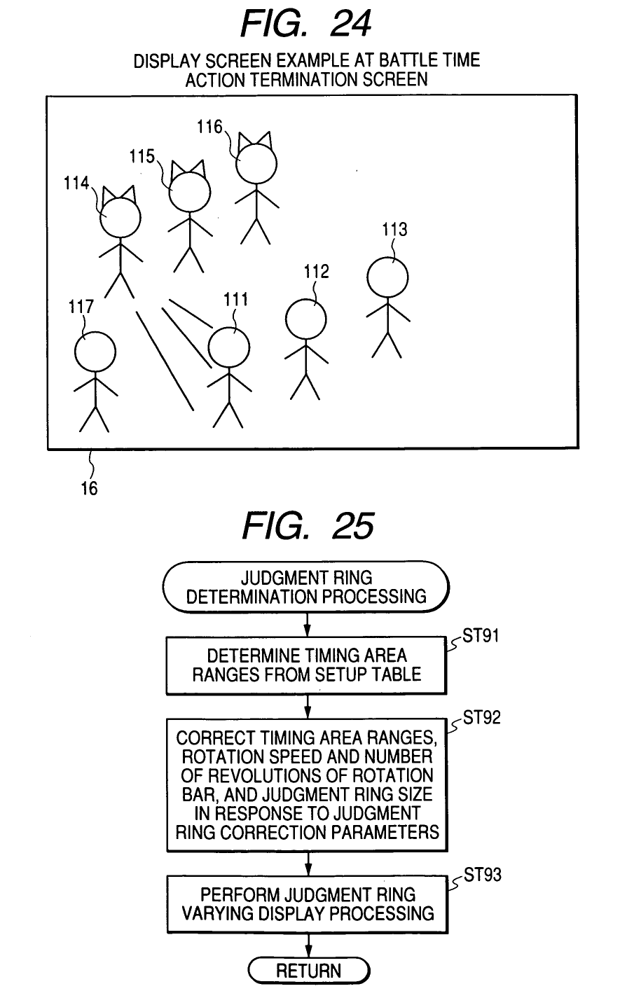

FIG. 24 shows a screen displayed when the main character A 111 terminates the attack on the enemy character A 114 and returns to the former position. Here, the time period from the start of action of the main character (containing itself) or an enemy character against the target character (the state shown in FIG. 23) to the termination of the action (the state shown in FIG. 24) is referred to as “a (one) turn” and display processing for the one turn is performed in the “effect image display processing” at ST86 in FIG. 15.

Judgment Ring Determination Processing

FIG. 25 shows a procedure of the “judgment ring determination processing” at ST82 in FIG. 15. Here, first any of the “arm table” (described later with FIG. 26), the “special table” (described later with FIG. 31), or the “item table” (described later with FIG. 33) set in the RAM 23 is referenced and the timing area ranges are determined (ST91). Subsequently, the timing area ranges determined at ST91, predetermined rotation speed and the predetermined number of revolutions of the rotation bar, and the size of the judgment ring are corrected based on judgment ring correction parameters described later (ST92). The rotation speed of the rotation bar is set to 1.5 seconds per round (revolution) as the basic speed, and the number of revolutions of the rotation bar is set to one as the basic number of revolutions. The judgment ring 100 is displayed in the timing area ranges finally determined at ST92 and rotation display of the rotation bar 101 is produced based on the determined rotation speed and the determined number of revolutions of the rotation bar 101 as judgment ring varying display processing (ST93). Then, the “judgment ring determination processing” is exited and the process returns to ST83 in FIG. 15. The timing areas and the judgment ring correction parameters are as follows:

FIG. 26 shows the “arm table.” The “arm table” is a table set when the player selects the FIGHT command. As shown in FIG. 26, the arms that can be used are defined according to the type of main character, and the used item individual skill and the range of each timing area are set in response to the type of arm. Information on the main character D is not listed in the table, but the arms that can be used are also defined for the main character D like the main characters A to C, and the used item individual skill and the range of each timing area are set in response to the type of arm.

The used item individual skill is used to calculate the damage amount to an enemy character (opposite character damage amount). The greater the numeric value of the used item individual skill, the larger the damage amount to the enemy character.

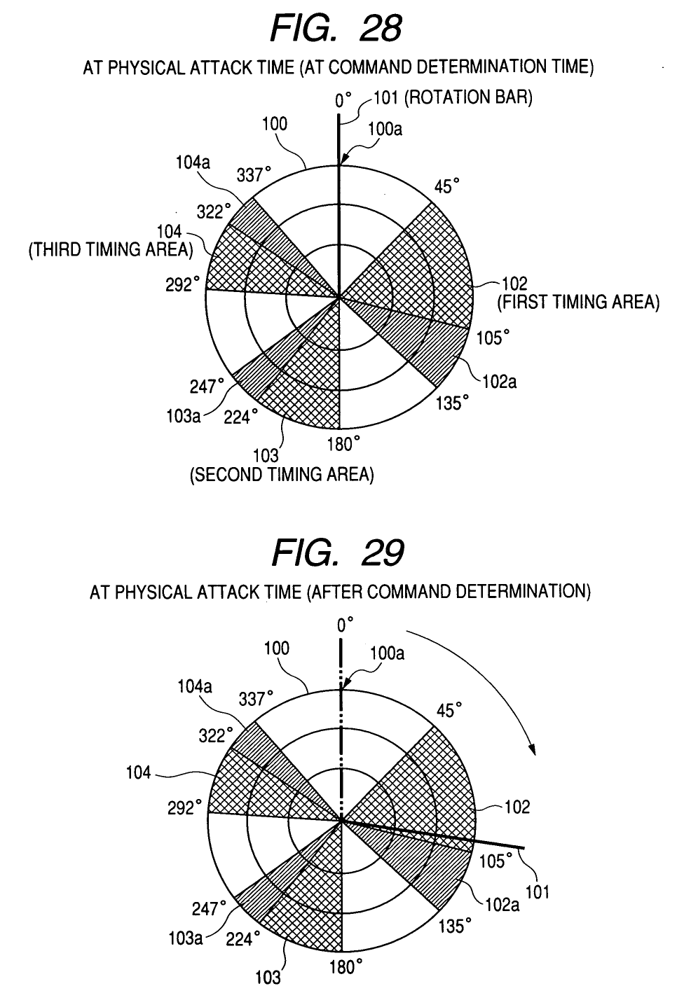

The range of each timing area is indicated by the angle range surrounded by the “start angle” and “end angle” with rotation start position of the rotation bar 101, 100a, as 0 degrees, as shown in FIG. 28. The “start angle” and “end angle” are set to different values in response to the type of used arm, as shown in FIG. 26. For example, if the main character is the main character A and the used arm is an arm A1, the range of the first timing area 102 is set to the 90-degree angle range of the start angle 45 degrees to the end angle 135 degrees. The range of the second timing area 103 is set to the 67-degree angle range of the start angle 180 degrees to the end angle 247 degrees. The range of the third timing area 104 is set to the 45-degree angle range of the start angle 292 degrees to the end angle 337 degrees.

In the judgment ring 100, a “120% area” is set as a special effective area in the predetermined range of each timing area; when the rotation bar passes through the area, if the player can operate the O button 12, the damage amount to the enemy character increases 20%, namely, becomes 1.2 times. The “120% area” is formed in the range of the angle position resulting from subtracting the angle of the “120% area” from the end angle to the end angle.

FIG. 27 shows a calculation expression for calculating the damage amount to the enemy character (opposite character damage amount).

“Assignment value” is set to 0.2 at the first attack time, 0.3 at the second attack time, and 0.5 at the third attack time, as shown in FIG. 27.

“SP remaining amount correction value” is 1 until the current SP falls below 25% of the maximum SP, namely, while “25−current SP/maximum SP×100≦0” is satisfied. When the current SP falls below 25% of the maximum SP, namely, when “25−current SP/maximum SP×100>0” is satisfied, 0.01 is added to the “SP remaining amount correction value” and the “SP remaining amount correction value” becomes 1.01. Then, whenever SP is decremented by one, 0.01 is added to the “SP remaining amount correction value.” That is, whenever SP is decremented by one, the opposite character damage amount is increased 1%.

“Character individual skill” means the STR (physical attack power) shown in FIG. 8, and “used item individual skill” is a value set in response to the types of main character and arm shown in FIG. 28.

“Judgment ring correction value” is 1.2 if the player operates the O button 12 when the rotation bar 101 is on the 120% area of any timing area; 1 if the player operates the O button 12 when the rotation bar 101 is on any other area than the 120% area of any timing area; or 0 if the player does not operate the o button 12 when the rotation bar 101 is on any timing area.

For example, if the FIGHT command is selected, when the player can well operate the O button 12 on the three timing areas, namely, when the player can operate the O button 12 when the rotation bar 101 is on the three timing areas, then the main character repeats an attack on the enemy character three times to give predetermined damage to the enemy character. For example, if the main character A uses the arm A1 to attack the enemy character, the opposite character damage amount at the first attack becomes “0.2×SP remaining amount correction value×STR×6×1 (1.2)” and as many points as the opposite character damage amount are subtracted from the HP of the enemy character. Likewise, the opposite character damage amount at the second attack becomes “0.3×SP remaining amount correction value×STR×6×1 (1.2)” and that at the third attack becomes “0.5×SP remaining amount correction value×STR×6×1 (1.2).” As many points as the opposite character damage amount are subtracted from the HP of the enemy character.

On the other hand, when the player upsets the operation timing of the O button 12 on one timing area, the later “judgment ring correction value” in the timing area becomes 0. For example, if the main character uses the arm A1 to attack the enemy character, when the player can operate the O button 12 when the rotation bar 101 is on the first timing area, the opposite character damage amount at the first attack becomes “0.2×SP remaining amount correction value×STR×6×1 (1.2).” However, when the player upsets the operation timing of the O button 12 on the second timing area, the “judgment ring correction value” at the second attack and that at the third attack become 0 and the opposite character damage amount also becomes 0.

When the HP of the enemy character becomes 0, it means that the main character beats the enemy character.

Judgment Ring Display Mode Processing

FIG. 28 shows the display mode of the judgment ring 100 displayed at the command determination time. It shows the judgment ring 100 displayed at the command determination time when the main character is the main character A, the arm A1 is used, and the FIGHT command is selected. The judgment ring 100 is formed according to the angle ranges of the timing areas set in the “arm table” shown in FIG. 26. If the main character is the main character A, the arm A1 is used, and the FIGHT command is selected, the start angle and the end angle of the first timing area 102 are 45 degrees and 135 degrees; those of the second timing area 103 are 180 degrees and 247 degrees; and those of the third timing area 104 are 292 degrees and 337 degrees. As shown in FIG. 28, the “120% area” in the first timing area 102 is a range 102a of 105 degrees resulting from subtracting 30 degrees from the end angle 135 degrees to the end angle 135 degrees; the “120% area” in the second timing area 103 is a range 103a of 224 degrees resulting from subtracting 23 degrees from the end angle 247 degrees to the end angle 247 degrees; and the “120% area” in the third timing area 104 is a range 104a of 322 degrees resulting from subtracting 15 degrees from the end angle 337 degrees to the end angle 337 degrees.

FIG. 29 shows the display mode of the judgment ring 100 after the command determination. It shows a state in which the rotation bar 101 starts to rotate and passes through the first timing area 102.

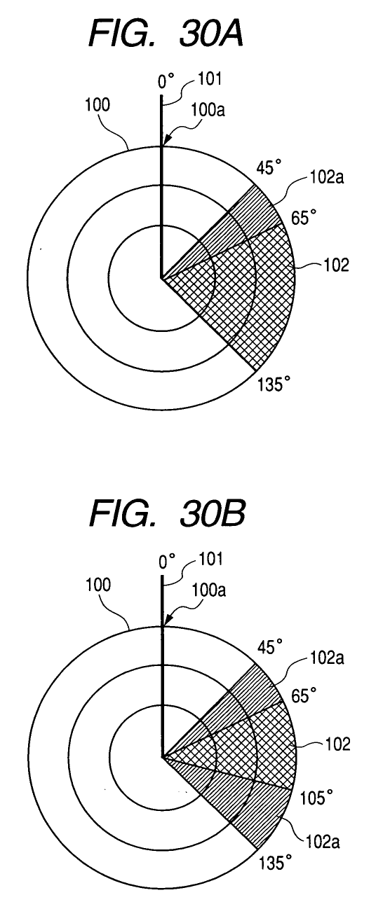

The “120% areas” are not limited to those described above. For example, the “120% area” may be provided in the range of the start angle to a predetermined angle as shown in FIG. 30A or two “120% areas” may be provided in one timing area as shown in FIG. 30B. FIG. 30A shows the case where the range 102a of the start angle 45 degrees to the angle 65 degrees (45 degrees+20 degrees) is set as the “120% area”. FIG. 30B shows the case where the range 102a of the start angle 45 degrees to the angle 65 degrees (45 degrees+20 degrees) and the range of the angle 105 degrees resulting from subtracting 30 degrees from the end angle 135 degrees to the end angle 135 degrees are set as the “120% areas”.

FIG. 31 shows the “special table.” The “special table” is a table set when the player selects the SPECIAL command. The SPECIAL command is a command using a special skill set for each character.

As shown in FIG. 31, the special skills that can be used are defined according to the type of main character, and the skill value and the range of each timing area are set for each special skill.

As shown in FIG. 31, when the main character is the main character A, attack spell 1 to attack spell 3 can be used as the special skills. The skill values set for them are used to calculate the opposite character damage amount to give damage to the enemy character using the attack spell 1 to the attack spell 3. In this case, the greater the skill value of the used special skill, the larger the damage amount to the enemy character, namely, the number of points to decrease the HP of the enemy character.

On the other hand, when the main character is the main character B, recovery spell 1 to recovery spell 3 can be used as the special skills. The skill values set for them are used to calculate the recovery value to recover an ally character using the recovery spell 1 to the recovery spell 3. In this case, the greater the skill value of the used special skill, the larger the recovery value of the ally character, namely, the number of points to recover the decreased HP of the ally character receiving damage from the enemy character.

The range of each timing area is indicated by the angle range surrounded by the “start angle” and “end angle” with rotation start position of the rotation bar 101, 100a, as 0 degrees, as with the “arm table” in FIG. 26. The “start angle” and “end angle” are set to different values in response to the type of used special skill. In addition, in the “special table,” only the first timing area 102 is set or only the first timing area 102 and the second timing area 103 are set depending on the type of used special skill. The main character C is not provided with such special skills and neither the skill value nor the timing area range is set in the “special table.”

FIG. 32A shows a calculation expression for calculating the opposite character damage amount when each of the attack spell 1 to the attack spell 3 is used as the special skill and FIG. 32B shows a calculation expression for calculating the recovery value when each of the recovery spell 1 to the recovery spell 3 is used as the special skill.

“Assignment value” is set to 0.2 at the first special skill use time, 0.3 at the second special skill use time, and 0.5 at the third special skill use time, as shown in FIG. 32B.

“Character individual skill” used with the calculation expression for calculating the opposite character damage amount when each of the attack spell 1 to the attack spell 3 in FIG. 32A means the INT (spell attack power) shown in FIG. 8. “Skill value of used special skill” is a skill value set in response to the types of main character and used special skill shown in FIG. 31.

“Judgment ring correction value” is 1.2 if the player operates the O button 12 when the rotation bar 101 is on the 120% area of any timing area; 1 if the player operates the O button 12 when the rotation bar 101 is on any other area than the 120% area of any timing area; or 0 if the player does not operate the O button 12 when the rotation bar 101 is on any timing area.

For example, if the SPECIAL command is selected for the main character A and attack spell is selected as the used special skill, when the player can well operate the O button 12 on all displayed timing areas, then the main character A attacks the enemy character using the selected attack spell to give predetermined damage to the enemy character. For example, if the main character A uses the attack spell 1 to attack the enemy character, the main character A attacks the enemy character using the attack spell only once because only one timing area is set. The opposite character damage amount at this time becomes “0.2×INT×99×1 (1.2)” from FIG. 32A and as many points as the opposite character damage amount are subtracted from the HP of the enemy character.

If the SPECIAL command is selected and recovery spell is selected as the used special skill, when the player can well operate the O button 12 on all displayed timing areas, then the main character works the selected recovery spell on an ally character for recovery. For example, if the main character B uses the recovery spell 1, the main character B uses the recovery spell on the ally character only once because only one timing area is set. The recovery value of the ally character at this time becomes “0.2×19×1 (1.2)” from FIG. 32B and as many points as the recovery value are added to the HP of the ally character.

FIG. 33 shows the “item table.” The “item table” is a table set when the player selects the ITEM command. The used item individual skill and the range of each timing area are set in response to the type of used item. As shown in the “item table,” items A to C can be used common to all main characters. Each of the items A to C is an item to recover the decreased HP of an ally character receiving damage from an enemy character. Therefore, the used item individual skill is used to calculate the recovery value to recover the ally character using each of the items A to C.

The calculation expression for calculating the recovery value when the main character uses each of the items A to C is the same as that in FIG. 32B, and “assignment value” is set to 0.2 at the first item use time and 0.3 at the second item use time.

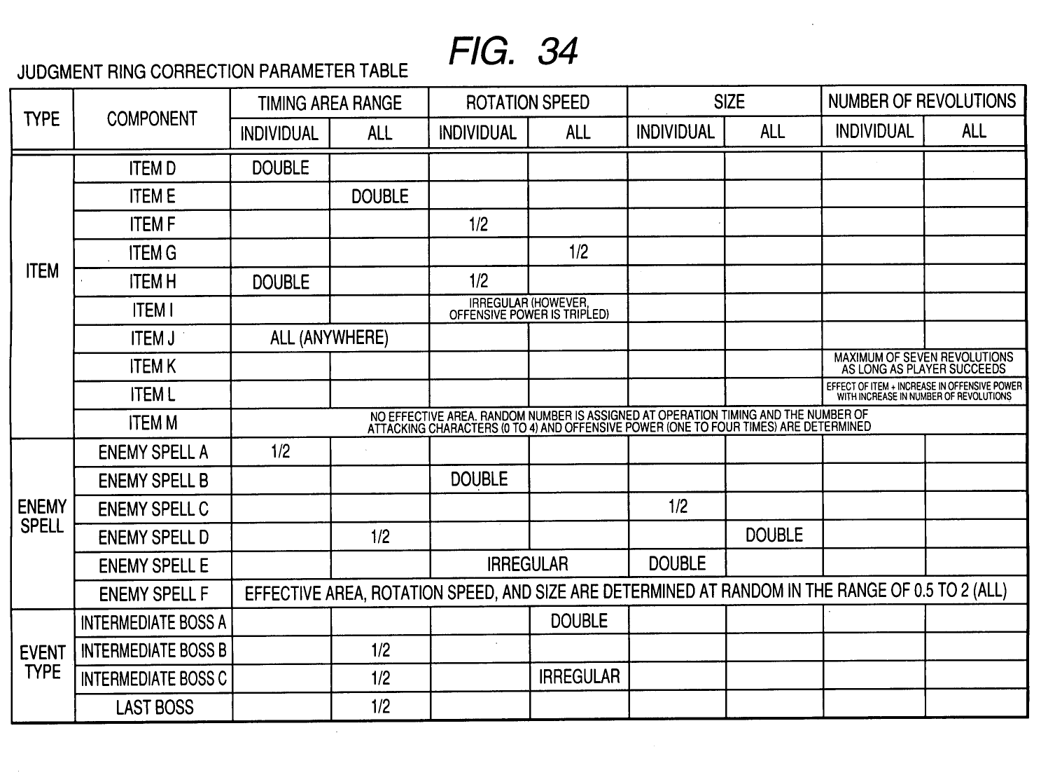

FIG. 34 shows a “judgment ring correction parameter table.” The “judgment ring correction parameter table” lists parameters for changing the display mode of the judgment ring 100 (ranges of timing areas, rotation speed and number of revolutions of rotation bar, and size of judgment ring), which will be hereinafter referred to as judgment ring correction parameters, and change in the display mode.

ITEM, ENEMY SPELL, and EVENT TYPE are included as the types of judgment ring correction parameters listed in the “judgment ring correction parameter table.”

As listed in the “judgment ring correction parameter table,” 10 types of items (item D to item M) are set in the judgment ring correction parameter ITEM, and it is made possible to obtain the items as the main character party clears a predetermined condition on each “sub-map.” To use the items at a battle scene or at a store, the display mode of the judgment ring 100 differs from the normal status and the judgment ring 100 is displayed in a very advantageous state to the player.

The advantages produced when the items are used are as follows:

(1) When the item D or the item E is used, the range of each timing area is widened twice. That is, the O button 12 becomes easy to operate.

(2) When the item F or the item G is used, the rotation speed of the rotation bar 101 is halved. That is, the O button 12 becomes easy to operate.

(3) When the item H is used, the range of each timing area is doubled and the rotation speed is halved.

(4) When the item I is used, the rotation speed of the rotation bar 101 changes irregularly as it is increased or decreased. However, if the player can well operate the O button 12, the attack power, namely, the opposite character damage amount is tripled as a very advantageous state.

(5) When the item J is used, the whole range on the judgment ring 100 becomes the timing area. That is, the player achieves success regardless of where the player operates the O button 12 on the judgment ring 100.

(6) When the item K is used, the number of revolutions of the rotation bar 101, which usually is one, becomes a maximum of seven. In this case, the player can operate the O button 12 with care.

(7) When the item L is used, the advantage of the item I also works, the number of revolutions increases, and the opposite character damage amount increases in response to the consumption number of the number of revolutions when the player succeeds in operating the O button 12.

(8) When the item M is used, no timing areas are displayed on the judgment ring 100, but the number of main characters for attacking and the attack power are determined at random in response to the operation timing of the O button 12.

In blanks in the “judgment ring correction parameter table,” the same mode as at the usual time is applied.

As the player gets the item D to the item M as the judgment ring correction parameters, it is made possible for the player to develop the game very advantageously and thus the items are set as rare items comparatively hard to get.

The ENEMY SPELL set as the judgment ring correction parameter means specific enemy spell of spell that the enemy character has (enemy spell). If the main character receives the enemy spell, the display mode of the judgment ring 100 becomes a disadvantageous state to the player. In the “judgment ring correction parameter table,” six types of enemy spell (enemy spell A to enemy spell F) are set in the judgment ring correction parameter ENEMY SPELL.

The advantages produced when the main character receives the enemy spell are as follows:

(1) When the main character receives the enemy spell A, the range of each timing area on the judgment ring 100 is halved.

(2) When the main character receives the enemy spell B, the rotation speed of the rotation bar 101 is doubled.

(3) When the main character receives the enemy spell C, the size of the judgment ring 100 is halved.

(4) When the main character receives the enemy spell D, the size of the judgment ring 100 is doubled, but the range of each timing area on the judgment ring 100 is halved.

(5) When the main character receives the enemy spell E, the size of the judgment ring 100 is doubled, but the rotation speed of the rotation bar 101 changes irregularly as it is increased or decreased. In this case, if the player can well operate the O button 12, the attack power remains the usual attack power although it is tripled with the item I.

(6) When the main character receives the enemy spell F, the range of each timing area, the rotation speed of the rotation bar 101, and the size of the judgment ring 100 are determined at random in the range of half to double.

The EVENT TYPE set as the judgment ring correction parameter is an event that the main character party fights a battle with a specific enemy character. When the event occurs, the display mode of the judgment ring 100 becomes a disadvantageous state to the player. In the “judgment ring correction parameter table,” four event types (intermediate bosses (middle bosses) A to C and wrath boss) are set in the judgment ring correction parameter EVENT TYPE.

The advantages produced when the event types occur are as follows:

(1) The event type INTERMEDIATE BOSS A is an event that the main character party encounters INTERMEDIATE BOSS A, one type of enemy boss character, and fights a battle therewith. When the event occurs, the rotation speed of the rotation bar 101 is doubled.

(2) The event type INTERMEDIATE BOSS B is an event that the main character party encounters INTERMEDIATE BOSS B, one type of enemy boss character, and fights a battle therewith. When the event occurs, the range of each timing area is halved.

(3) The event type INTERMEDIATE BOSS C is an event that the main character party encounters INTERMEDIATE BOSS C, one type of enemy boss character, and fights a battle therewith. When the event occurs, the range of each timing area is halved and further the rotation speed of the rotation bar 101 changes irregularly as it is increased or decreased.

(4) The event type WRATH BOSS is an event that the main character party encounters WRATH BOSS, one type of enemy boss character, and fights a battle therewith. When the event occurs, the range of each timing area is halved.

The boss character is an enemy character for enabling the player to get a very large number of experience points as the player beats the boss character, as compared with the usual enemy character and therefore the display mode of the judgment ring 100 becomes a state in which the player is hard to operate the O button 12, as described above.

Judgment Ring Determination Processing

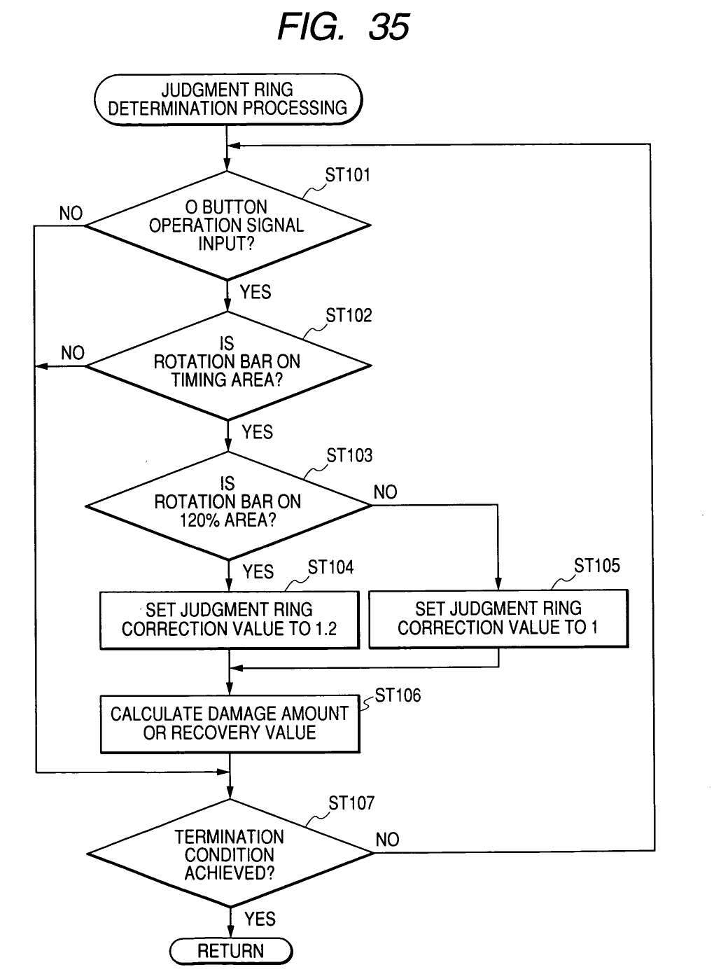

FIG. 35 shows a procedure of the “judgment ring determination processing” at ST83 in FIG. 15. This processing is processing after rotation of the rotation bar 101 in the judgment ring 100 is started in the “judgment ring determination processing.” First, whether or not the player operates the O button 12 and the operation signal is input is determined (ST101) When the determination at ST101 is NO, the process proceeds to ST107. When the determination is YES, namely, when it is determined that the operation signal is input, subsequently whether or not the rotation bar 101 is on any of the timing areas is determined (ST102).

When the determination at ST102 is NO, the process proceeds to ST107. When the determination is YES, namely, when the rotation bar 101 is on any of the timing areas, subsequently whether or not the position of the rotation bar 101 is on a 120% area is determined (ST103). The case where the determination at ST102 is NO is the case where the player cannot operate the O button 12 when the rotation bar 101 is on the timing area. In this case, the later operation of the O button 12 becomes ineffective, and the display termination conditions of the judgment ring 100 are achieved.

When the determination at ST103 is YES, namely, when the rotation bar 101 is on a 120% area, the judgment ring correction value 1.2 is set in a predetermined area of the RAM 23 (ST104). On the other hand, when the determination at ST103 is NO, namely, the rotation bar 101 is on the timing area other than a 120% area, the judgment ring correction value 1 is set in a predetermined area of the RAM 23 (ST105).

Subsequently, the opposite character damage amount or the recovery value is calculated according to the predetermined calculation expression based on the selected command, the type of main character, and the used item, and the calculation result is set in a predetermined area of the RAM 23 (ST106).

At ST107, whether or not the display termination conditions of the judgment ring 100 are achieved is determined. The termination conditions are (1) consumption of the specified number of revolutions (which is usually one; may increase in response to the judgment ring correction parameter) and (2) consumption of the specified number of observation push times (which is usually three; may change in response to various parameters). When the determination at ST107 is YES, the “judgment ring determination processing” is exited and the process returns to ST84 in FIG. 15; when the determination is NO, the process returns to ST101.

FIG. 36 shows a procedure of main character status change processing.

In the main character status change processing shown in FIG. 36, the “status” of a specific main character is changed as a predetermined condition is satisfied. The four types of “status” of the specific main character are set: “normal status” and three types of “special status” (“special status A,” “special status B,” and “special status C”). (See FIG. 37.) A different advantage is set for each of the three types of “special status.” The advantage is conducted for the specific main character in a battle scene in which the specific main character making a transition to the “special status” takes part. The “status” of the specific main character is controlled so as to change among the four types of “status” by performing change control of “biorhythm” (see FIG. 38) set for the specific main character or the like. Further, the change control of “biorhythm” is performed in response to the number of battles between the main character and an enemy character. A specific processing flow of the “main character status change processing” is described later. First, the four types of “status” set for the specific main character will be discussed based on a “status table” in FIG. 37.

“Status,” “advantage,” and “change condition” are recorded in the “status table” in FIG. 37 in association with each other.

The “status” indicates the “status” of the specific main character changing by performing change control of “biorhythm” set for the specific main character or the like. The four types of “status” are set: “special status A,” “special status B,” “special status C,” and “normal status”. A different “advantage” is set for each of the four types of “status.”

The “advantage” indicates specific advantage conducted only for the specific main character in a battle scene set in response to each of the four types of “status” (“special status A,” “special status B,” “special status C,” and “normal status”). The “special status A,” “special status B, ” “special status C,” and “normal status” are as follows:

The “advantage” such that “an enemy character does not attack the main character. The avoidance percentage of a physical attack of an enemy character is 100%” is set for the “special status A.” That is, if the “status” of the specific main character in a battle scene is the “special status A,” the main character on which an enemy character is to make an attack is selected from among the main characters other than the specific main character based on the setup “advantage.” If the specific main character makes a battle solely (if the specific main character only exists as the main character), an enemy character may attack the specific main character. Further, if an enemy character is to attack a predetermined range rather than the main character singly and the specific main character exists in the attacked range, the enemy character may attack the specific main character.

The “advantage” such that “HP decreases (for example, to a quarter) and the physical offensive force is raised (for example, three times). Only ATTACK and ITEM commands can be selected” is set for the “special status B.” That is, if the “status” of the specific main character in a battle scene is the “special status B,” the numeric value of the HP set for the specific main character is decreased (for example, a quarter) and the physical offensive force (STR, see FIG. 8) is set several-fold (for example, three times) based on the setup “advantage.” Further, any other command than ATTACK or ITEM is made ineffective.

The “advantage” such that “the parameters are raised on a whole. SPECIAL command can be selected” is set for the “special status C.” That is, if the “status” of the specific main character in a battle scene is the “special status C,” the individual skill values (HP, MP, SP, physical attack power (STR), physical defence power (VIT), agility (AGL), spell attack power (INT), spell defence power (POW), and luck (LUC)) set for the specific main character are raised (for example, 10 points are added) based on the setup “advantage.” On the command selection screen (FIG. 9), the SPECIAL command is added and can be selected.

The “advantage” is not for the “normal status.” That is, if the “status” of the specific main character in a battle scene is the “normal status,” the individual skill values, etc., set for the specific main character are not changed.

Thus, different types of “status” involving different advantages are set for the specific main character, so that it is made possible to change the status of the specific main character regardless of the level of the specific main character. Therefore, change in the specific main character also becomes multifaceted, the interest in the game can be augmented, and the battle with the enemy character is repeated as change in the specific main character is expected; the interest of the player in the battle scene can be increased.

Further, “change condition” listed in the “status table” in FIG. 37 indicates the condition as a trigger for changing the “status” of the specific main character. The “status” of the specific main character is controlled so as to change among the four types of “status” by performing change control of “biorhythm” (see FIG. 38) set for the specific main character or the like. The “change conditions” set in a one-to-one correspondence with the types of “status” will be discussed with FIG. 38.

FIG. 38 shows the “biorhythm” set for the specific main character. As shown in FIG. 38, the “biorhythm” is represented by a reference line 131 represented by a horizontal line, a period A 132 represented by a wave line made up of solid squares in the figure having predetermined interval, and a period B 133 represented by a wave line made up of open stars in the figure having predetermined interval different from that of the period A 132. A reference point P 130 is represented on the reference line 131.

Change control of the “biorhythm” is performed so that the period A 132 and the period B 133 move from right to left (see arrows in the figure) with the continuous forms with the fixed positions of the reference line 131 and the reference point P 130. The move of the period A 132 and the period B 133 is controlled so that they move a predetermined length each time a battle is executed between main and enemy characters. For example, change control is performed so that each period moves one frame (one solid square or one open star in the figure) from right to left at the battle start or end time (except during the battle). After the change control is performed, whether or not each period matches the position of the reference point P 130 is determined. The “status” is controlled so as to change among the four types of “status” in response to the determination result.

Thus, change control of the “biorhythm” is performed as a battle is executed between main and enemy characters, so that it is made possible to freely change the “status” of the main character depending on whether or not the player fights a battle, the pleasure of the play is increased, and the interest in the play can be augmented.

The change control of the “biorhythm” is performed based on the number of times a battle has been executed and is not performed during the battle execution. That is, the change control of the “biorhythm” is performed before or after each battle. Thus, the player can be prevented from being puzzled with change in the “status” of the specific main character during the battle and can easily devise a stratagem during the battle and concentrate on the battle.

In the embodiment, the change control is performed so that the period A 132 and the period B 133 move from right to left (see the arrows in the figure) with the continuous forms with the fixed positions of the reference line 131 and the reference point P 130. However, the invention is not limited to the mode; the change control may be performed so that the position of the reference point P 130 moves from right to left with the fixed positions of the reference line 131 and the periods A 132 and B 133.

The period A 132 corresponds to the “special status A” and change to the “special status A” is made if it is determined that the period A 132 (an intersection point 134 of the period A 132 and the reference line 131) matches the position of the reference point P 130 (see FIG. 39). That is, the “change condition” to the “special status A” is set as the case where it is determined that the period A 132 matches the position of the reference point P 130 (see FIG. 37) and when the “change condition” is satisfied, the “status” of the specific main character is changed to the “special status A.” FIG. 39 is a drawing to show a state in which the period A 132 (the intersection point 134 of the period A 132 and the reference line 131) matches the position of the reference point P 130 as change control is performed because of the main character taking part in a plurality of battles from the state in FIG. 38.

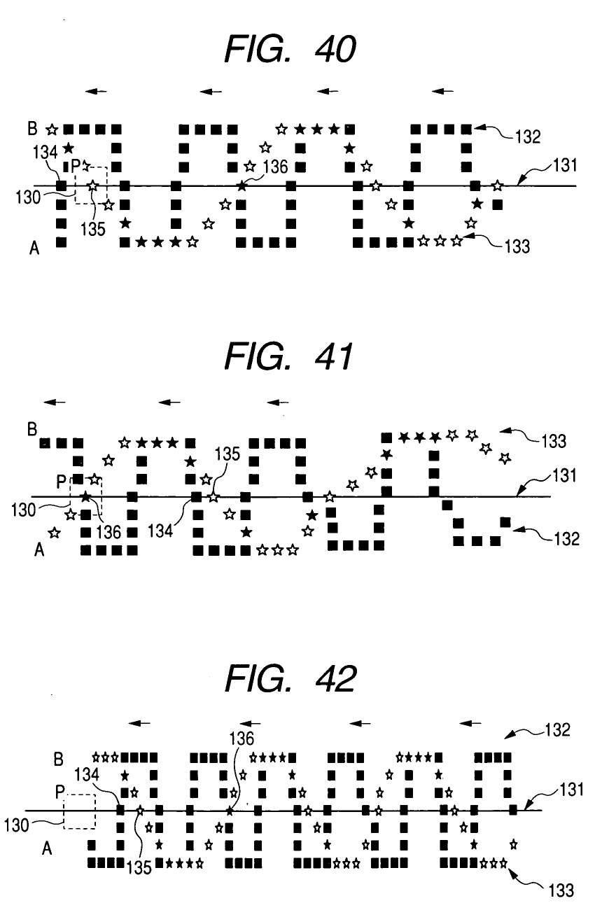

The period B 133 corresponds to the “special status B” and change to the “special status B” is made if it is determined that the period B 133 (an intersection point 135 of the period B 133 and the reference line 131) matches the position of the reference point P 130 (see FIG. 40). That is, the “change condition” to the “special status B” is set as the case where it is determined that the period B 133 matches the position of the reference point P 130 (see FIG. 37) and when the “change condition” is satisfied, the “status” of the specific main character is changed to the “special status B.” FIG. 40 is a drawing to show a state in which the period B 133 (the intersection point 135 of the period B 133 and the reference line 131) matches the position of the reference point P 130 as change control is performed because of the main character taking part in a plurality of battles from the state in FIG. 38.

Further, change to the “special status C” is made if it is determined that both of the periods A 132 and B 133 (an intersection point 136 of the periods A 132 and B 133 and the reference line 131) match the position of the reference point P 130 (see FIG. 41). That is, the “change condition” to the “special status C” is set as the case where it is determined that both of the periods A 132 and B 133 match the position of the reference point P 130 (see FIG. 37) and when the “change condition” is satisfied, the “status” of the specific main character is changed to the “special status C.” FIG. 41 is a drawing to show a state in which both of the periods A 132 and B 133 (the intersection point 136 of the periods A 132 and B 133 and the reference line 131) match the position of the reference point P 130 as change control is performed because of the main character taking part in a plurality of battles from the state in FIG. 38.

Further, change to the “normal status” is made if it is determined that neither the period A 132 (the intersection point 134 of the period A 132 and the reference line 131) nor the period B 133 (the intersection point 135 of the period B 133 and the reference line 131) matches the position of the reference point P 130 (see FIG. 38). That is, the “change condition” to the “normal status” is set as the case where it is determined that neither the period A 132 nor the period B 133 matches the position of the reference point P 130 (see FIG. 37) and when the “change condition” is satisfied, the “status” of the specific main character is changed to the “normal status.”

In the embodiment, the change conditions of the “status” of the specific main character have been described by taking the change control of the “biorhythm” as an example. However, the invention is not limited to the above configuration and the following mode may be adopted: As another configuration, s number of change condition times is set for each type of “status.” The number of change condition times may include a number of times the player character encountered a specific episodes in the game, the number times the map has been switched, and the number of time the battle has been fought between the player character and the enemy character.

For example, the number of change condition times is set for the “special status A” so as to become multiple of 5 such as 5, 10, 15, 20 . . . (whereby it becomes a period having predetermined interval). The number of change condition times is set for the “special status B” so as to become multiple of 4 such as 4, 8, 12, 16, 20 . . . (whereby it becomes a period having predetermined interval). Further, for the “special status C,” the number of times common to the number of change condition times to the “special status A” and that to the “special status B” (20, 40) is set as the number of change condition times (intersection point of the two periods). Thus, in the game according to the invention, the numeric values of the number of change condition times are set as desired, so that the interval magnitude of the period can be adjusted as desired.

Whenever a battle is executed, the number of times a battle has been fought is counted. If the count reaches the number of change condition times, the status is changed to the “status” responsive to the number of change condition times. For example, if the count is 5, the status is changed to the “special status A.” For example, if the count is 20, the status is changed to the “special status C.”

Thus, in the gaming program according to the invention, status change control means has the function of changing the status of the player character if the number of times a battle between the player character and an enemy character has been fought reaches the predetermined number of times, so that the status of the player character changes regardless of the level, it is made possible to freely change the status of the player character depending on whether or not the player causes the player character to take part in a battle, the pleasure of the game is increased, and the interest in the game can be augmented.

In the example, the setup numbers of change condition times are a sequence of multiples to set a period having regular interval, but may be an irregular sequence to set a period having irregular interval. Accordingly, the player becomes hard to keep track of the timing at which the “status” of the specific main character changes, so that it can be expected that an unforeseen game will be provided, and the player's interest in the game may be augmented.

In the embodiment, the change control of the “biorhythm” may be performed in response to the number of times a battle between main and enemy characters has been fought and in addition, may be performed in response to execution of a “special item,” a “special accessory,” etc., concerning change in the “biorhythm” or the “status.” The main character is caused to get the “special item,” the “special accessory,” etc., in response to the progress of the game.

For example, if the specific main character is equipped with the “special accessory” concerning change in the “biorhythm” on the menu screen (see FIGS. 43 and 44), the period of the “biorhythm” is changed. Changing the period means widening or narrowing the interval of the period represented as a wave line.

FIG. 42 shows a state in which the period of the “biorhythm” is changed as the specific main character is equipped with the “special accessory” concerning change in the “biorhythm.” Making a comparison between the state in FIG. 42 and the state of the “biorhythm” before the character is equipped with the “special accessory” in FIG. 38, the periods A 132 and B 133 represented in the “biorhythm” shown in FIG. 42 change so that the intervals of the periods represented by the wave lines become narrower than those in FIG. 38.

Thus, the period is changed so that the interval of the period is narrowed, whereby the number of the intersection points of the period A 132 or B 133 and the reference line 131 is also increased. Accordingly, it is made possible to frequently change the “status” of the specific main character and it is made possible to increase the interest of the player in the battle scene.

In the embodiment, both the periods A 132 and B 133 are changed as the specific main character is equipped with the “special accessory” concerning change in the “biorhythm,” but the invention is not limited to it. Either the period A 132 or B 133 may be changed. Accordingly, it is made possible to select the “status” to be frequently changed and the pleasure of devising a stratagem as to which “status” a battle is to be fought in occurs; the interest in the game can be augmented.

For example, to cause the specific main character to use the “special accessory” concerning change in the “status” on the “menu screen” on the world map or a sub-map or the “command screen” in a battle scene, the “status” is changed to any of the four types of “status” independently of the “biorhythm.”

The duration of the “status” to which the “status” is changed to cause the specific main character to use the “special accessory” on the “menu screen” is until execution of map switch, such as switch from the world map to a sub-map or sub-map-to-sub-map switch (such as moving in to a new town); meanwhile, the “status” to which the “status” is changed continues. The duration of the “status” to cause the specific main character to use the “special accessory” on the “command screen” in a battle scene is only during the battle scene using the “special item,” and after the termination of the battle, the “status” is changed based on the “biorhythm.” While the “status” changes according to the “special item,” the change control of the “biorhythm” (move of the periods A and B) is performed, but change in the “status” based on the “biorhythm” is not made. That is, change in the “status” based on the “special item” takes precedence over change in the “status” based on the “biorhythm.” While the “status” changes according to the “special item,” the change control of the “biorhythm” (move of the periods A and B) may be suppressed.

Thus, the “special item” responsive to each type of “status” is set, so that the player can change the “status” of the specific main character to any desired “status” at any time, the pleasure of devising a stratagem as to which “status” a battle is to be fought in occurs, and the interest in the game can be augmented.

In the invention, the “status” of the specific main character may be forcibly changed according to an “event,” etc., executed in response to the progress of the game in addition to the above-described conditions.

Referring again to FIG. 36, the specific processing flow of the “main character status change processing” will be discussed. This processing is executed by the CPU 21 of the main unit 1 following the gaming program stored in the RAM 23 from the DVD-ROM 31 in accordance with the basic operation program such as the OS (Operating System) stored in the ROM 22.

First, the CPU 21 determines whether or not a battle has been fought (ST111). At this step, whether or not a battle has been fought between main and enemy characters is determined. When the determination at ST111 is YES, the process proceeds to ST112; when the determination is NO, the process proceeds to ST115.

Next, at ST112, number-of-battle-times count processing is performed. In this processing, 1 is added to a number-of-battle-times counter stored in a predetermined area of the RAM 23. The process proceeds to ST113.

Next, at ST113, time axis move processing is performed. In this processing, change control is performed so as to move the periods A 132 and B 133 of the “biorhythm” from right to left (see the arrows in FIG. 38) as described above. The process proceeds to ST114.

Next, at ST114, status determination processing is performed. In this processing, whether or not the position of the reference point P130 represented in the “biorhythm” and the period moved by performing the processing at ST113 match is determined. An identifier corresponding to the determined “status” is recorded in a predetermined area of the RAM 23 based on the determination result. For example, if it is determined that the period A 132 matches the position of the reference point P130, an identifier “1” corresponding to the “special status A” is recorded in the position of a “status identifier” stored in the RAM 23. For the “special status B,” an identifier “2” is recorded; for the “special status C,” an identifier “3” is recorded; and for the “normal status,” an identifier “0” is recorded. Then, the process proceeds to ST115.

Next, at ST115, whether or not the specific main character is equipped with a specific accessory is determined. In this processing, whether or not the specific main character is equipped with the “special accessory” concerning change in the “biorhythm” or the “status” is determined. When the determination at ST115 is YES, the process proceeds to ST116; when the determination is NO, the process proceeds to ST117.

Next, at ST116, period change processing is performed. In this processing, the period of the “biorhythm” is changed. Changing the period means widening or narrowing the interval of the period represented as a wave line (see FIG. 42). Then, the process proceeds to ST117.

Next, at ST117, whether or not a specific item is used is determined. In this processing, whether or not the specific main character is caused to use the “special item” concerning change in the “biorhythm” or the “status” is determined. When the determination at ST117 is YES, the process proceeds to ST118; when the determination is NO, the “main character status change processing” is exited.

Next, at ST118, status change processing is performed. In this processing, the “status” of the specific main character is changed to any of the four types of “status” in response to the used “special item” independently of the “biorhythm.” For example, to cause the specific main character to use the “special item” for changing the “status” to the “special status A,” the identifier “1” corresponding to the “special status A” is recorded in the position of the “status identifier” stored in the RAM 23. For the “special status B,” the identifier “2” is recorded; for the “special status C,” the identifier “3” is recorded; and for the “normal status,” the identifier “0” is recorded. Then, the process proceeds to ST119.

Next, at ST119, image display processing is performed. In this processing, an effect image of change in the “status” of the specific main character, change in the “biorhythm,” etc., executed by performing the above-described processing is displayed (for example, see FIG. 43, FIG. 44, etc.,). For example, as a character image responsive to the “status” of the specific main character, a character effect image with the image of the specific main character made the same as the background like disappearance is displayed in the “special status A.” A character effect image as the specific main character is transformed into a monster is displayed is displayed in the “special status B.” Further, a character effect image with aura occurring around the body of the character is displayed is displayed in the “special status C.” In any type of “status,” preferably a character effect image on which the “advantage” of the “status” is reflected is displayed different from any other type of “status.” After ST119, the “main character status change processing” is exited.

The change in the “status” of the specific main character, the change in the “biorhythm,” etc., executed by performing the “main character status change processing,” and the like are displayed on a “status” screen shown in FIG. 43 and a “biorhythm” screen shown in FIG. 44, enabling the player to check them.

The “status” screen shown in FIG. 43 or the “biorhythm” screen shown in FIG. 44 is displayed as the player selects the specific main character on the “menu screen” and enters a BIORHYTHM command. The “menu screen” is displayed as the player operates the □ button 14 of the controller 4 on the world map or a sub-map. The “menu screen” enables the player to check and change the data set for each main character.

FIG. 43 shows the “status” screen. The “status” screen is displayed as the player places the cursor on the specific main character (for example, the main character A) among the options of the main characters and operates the O button 12. Options including BIORHYTHM are displayed in the upper right portion of the “status” screen and the cursor is displayed so that the player can select one of them by operating the controller 4. The “status” of the main character A (“special status A,” “special status B,” “special status C,” or “normal status”) is displayed at the center of the left of the “status” screen. For example, the “status” name (“normal status” in the figure) and explanation of the “status” (“the character is in normal status” in the figure) are displayed.

As the player selects EQUIP from among the options displayed in the upper right portion of the “status” screen, the specific main character can be equipped with the “special accessory” concerning change in the “biorhythm.” Further, the player can also cause the specific main character to use the “item” for changing the “status” of the specific main character to the “special status” and equip the specific main character with the “item” on the “status” screen.

FIG. 44 shows the “biorhythm” screen. The “biorhythm” screen is displayed as the player places the cursor on BIORHYTHM by operating the up button 7 or the down button 8 of the controller 4 on the “biorhythm” screen and then operates the O button 12. That is, the “biorhythm” screen displays the status of “biorhythm” as shown in FIGS. 38 to 42.

The player can display the “status” screen shown in FIG. 43 and the “biorhythm” screen shown in FIG. 44 to check the “status” of the specific main character and “biorhythm”, so that the pleasure of devising a stratagem as to which “status” the specific main character is caused to take part in a battle in occurs, and the interest in the game can be augmented. The “status” screen and the “biorhythm” screen are only display examples and the invention is not limited to them. In the embodiment, the “status” screen, the “biorhythm” screen is displayed as the player enters the BIORHYTHM command on the “menu screen,” but the invention is not limited to the mode and the “status” screen, the “biorhythm” screen may be displayed as the player enters a predetermined command in a battle scene. Accordingly, the player can also check the “status” of the specific main character, the state of the “biorhythm” in the battle.

In the embodiment, the change control of the “biorhythm” is executed as a battle between main and enemy characters is fought (YES at ST7 in FIG. 4), but the invention is not limited to the mode and various conditions can be set. For example, the change control of the “biorhythm” may be performed in response to the number times the player character encountered a specific “episodes” in the game, the number of times the map has been switched between the world map and a sub-map, the moving distance on the world map or a sub-map, etc., executed in the progress of the game.

The embodiment of the invention has been described, but the invention is not limited to the specific embodiment. For example, the controller 4 operated by the player may be made integral with the main unit 1.

Further, the invention can also be applied to a portable gaming machine or a desk-top gaming machine including in one piece an operation unit that can be operated by a player, a display section for displaying an image and audio (sound), a storage section for storing a gaming program, and a control section for executing control processing following the gaming program.

Further, the invention can also be applied to a network game of the type wherein the above-mentioned gaming program is stored in a server connected to a network such as Internet 56 and a player can play a game by connecting to the server from a personal computer, a mobile telephone, a portable information terminal (PDA), and the like.

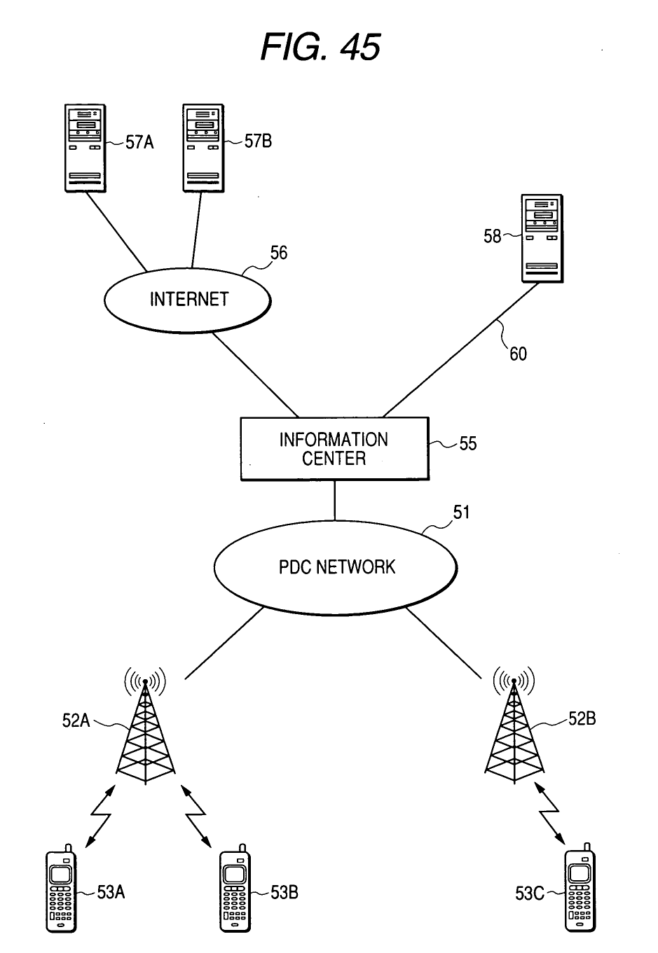

A network game system will be discussed with FIG. 45 by way of example. In the network game system, mobile telephones 53A, 53B, and 53C as terminals for playing a game are connected to a PDC network 51 capable of conducting packet communications, for example, through base stations 52A and 52B, and an information center 55 is accessed through the PDC network 51 in response to player's operation and the game state. The information center 55 acquires various pieces of information through a network such as Internet 56 from servers 57A and 57B storing data required for games and the like as well as game programs in response to requests from the mobile telephones 53A, 53B, and 53C, and transmits information required for games to the mobile telephones 53A, 53B, and 53C. Like a server 58 in FIG. 45, the server storing the game data, etc., may be connected to the information center 55 by a private or leased communication line 60 not via the network such the Internet 56.

To play a game, the player previously downloads a game program from the server 57A, 57B into the mobile telephone 53A, 53B, 53C and executes the game program on the mobile telephone 53A, 53B, 53C. In addition, various systems are possible, such as a system wherein the mobile telephone 53A, 53B, 53C is assigned a role like a browser in such a manner that the game program is executed on the server 57A, 57B in accordance with an instruction from the mobile telephone 53A, 53B, 53C and the player views the game on the mobile telephone 53A, 53B, 53C. The players may share the network game system or may be able to fight a battle with each other by connecting the mobile telephones using the PDC network 51.

Further, the advantages described in the specification are only enumeration of the most favorable advantages produced from the invention, and the advantages of the invention are not limited to those described in the specification.

### ADVANTAGES OF THE INVENTION

According to the invention, change in the player character also becomes multifaceted, the interest in the game can be augmented, and the battle with the enemy character is repeated as change in the player character is expected; the interest of the player in the battle scene can be increased.

As described above, according to one aspect of the invention, there are provided a gaming program, a gaming machine, and a record medium recording the gaming program, comprising status change control means for changing the status of the player character if a predetermined condition is satisfied.

More particularly, according to the invention, the following are provided:

(1) A gaming program executed by a computer including operation unit (for example, controller 4) that can be operated by a player, for displaying a player character (for example, main character A 111, etc.,) and an enemy character (enemy character A 114) on a screen (for example, screen 16) of an existing display or a separate display, determining an action mode (for example, move on a map, ATTACK, SPECIAL, etc., in a battle scene) for any of player characters in response to entry operation through the operation unit, and displaying a battle between the player character and the enemy character (for example, battle scene as shown in FIG. 6 or the like) on the screen to proceed a game, characterized in that the computer is caused to function as status change control means (for example, CPU 21, ROM 22, RAM 23, DVD-ROM 31, memory card 32, etc., and in particular, “status table” in FIG. 37, “main character status change processing” in FIG. 36, etc.,) for changing the status of the player character (for example, “status” of specific main character, status of “biorhythm,” etc.,) if a predetermined condition is satisfied (for example, YES at ST111, ST115, ST117 in FIG. 36, execution of ST114, etc.,).

(2) In the gaming program described in (1), the predetermined condition is satisfied (for example, status in FIGS. 39 to 41) in response to the number of times a battle has been fought between the player character and the enemy character (for example, YES at ST7 in FIG. 4) and the status change control means has a function of changing the status of the player character if the predetermined condition is satisfied.

In the gaming program described in (1) or (2), the status change control means has the function of changing the status of the player character except while a battle between the player character and the enemy character is displayed on the screen.

In the gaming program described in any of (1) to (3), the computer is caused to function as condition change control means (for example, CPU 21, ROM 22, RAM 23, DVD-ROM 31, memory card 32, etc., and in particular, execution of ST116 in FIG. 36, etc.,) for changing the predetermined condition to a different condition if a specific item concerning change in the status of the player character (for example, “special accessory” concerning change in “biorhythm” or the like) is selected (for example, YES at ST115 in FIG. 36) in response to entry operation (for example, command, etc.,) through the operation unit.

The expression “when a specific item is selected” is used to contain the case where not only a command for causing the player character to use a specific item (“special item,” “special accessory,” etc.,), but also a command for equipping the player character with a specific item is selected.

(5) A gaming machine including operation unit that can be operated by a player and a main unit for displaying a player character and an enemy character on a screen of an existing display or a separate display, determining an action mode for any of player characters in response to entry operation through the operation unit, and displaying a battle between the player character and the enemy character on the screen to proceed a game, characterized in that the main unit includes status change control means for changing the status of the player character if a predetermined condition is satisfied.

(6) A computer-readable record medium recording a gaming program executed by a computer including operation unit that can be operated by a player, for displaying a player character and an enemy character on a screen of an existing display or a separate display, determining an action mode for any of player characters in response to entry operation through the operation unit, and displaying a battle between the player character and the enemy character on the screen to proceed a game, characterized in that the gaming program causes the computer to function as status change control means for changing the status of the player character if a predetermined condition is satisfied.

### ADVANTAGE OF THE INVENTION

According to the invention (1), (5), or (6), it is made possible to change the status of the player character regardless of the level of the player character. Therefore, change in the player character also becomes multifaceted, the interest in the game can be augmented, and the battle with the enemy character is repeated as change in the player character is expected; the interest of the player in the battle scene can be increased.

According to the invention (2), it is made possible to freely change the status of the player character depending on whether or not the player causes the player character to take part in a battle, the pleasure of the game is increased, and the interest in the game can be augmented.

According to the invention (3), the player can be prevented from being puzzled with change in the status of the player character during the battle and can easily devise a stratagem during the battle and concentrate on the battle.

According to the invention (4), it is made possible to change the condition for changing the status of the player character by operation of the player, so that the player can freely change the timing for changing the status of the player character, the pleasure of devising a stratagem occurs, and the interest in the game can be augmented.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the -particular use contemplated. It is intended that the scope of the invention be defined by the claims appended hereto, and their equivalents.

What is claimed is:

1. A gaming machine for allowing a player to enter an action command of a player character to proceed a game, the gaming machine comprising:
an operation unit that allows the player to enter the action command;
a display controller that displays the player character and an enemy character on a display for displaying the progress of the game and displaying a battle between the player character and the enemy character on the display; and
a status controller that changes a status of the player character when a predetermined condition is satisfied.

2. The gaming machine as claimed in claim 1, wherein the status controller determines whether or not the condition is satisfied based on a number of times a battle has been fought between the player character and the enemy character.

3. The gaming machine as claimed in claim 1, wherein the status controller determines whether or not the condition is satisfied based on a number of times the player character has encountered a specific episode with the progress of the game.

4. The gaming machine as claimed in claim 1, wherein the status controller determines whether or not the condition is satisfied based on a number of times a map of the game in which the player character is positioned has been switched.

5. The gaming machine as claimed in claim 1, wherein the status controller determines whether or not the condition is satisfied based on a moving distance of the player character on the map in the game.

6. The gaming machine as claimed in claim 1, wherein the status controller changes the status of the player character during a period when a battle is not fought between the player character and the enemy character.

7. The gaming machine as claimed in claim 1, wherein the status controller changes the condition when the player character is equipped with a predetermined accessory.

8. The gaming machine as claimed in claim 1, wherein the status controller changes the status of the player character independently of changing the status based on the condition when the player character uses a predetermined item.

9. The gaming machine as claimed in claim 1 further comprising:
a skill parameter storage that stores a parameter indicating a skill of the player character concerning a battle; and
a status table storage that stores a status table for indicating a relationship among different types of status to which the player character can belong, the effect of each of the different types of status on the parameter, and a condition for changing the status of the player character to at least one of the different types of status,
wherein when the condition indicated in the status table stored in the status table storage is satisfied, the status controller changes the status of the player character to the status corresponding to the condition which is satisfied.

10. The gaming machine as claimed in claim 1, wherein the status controller:
virtually provides a reference line, a reference point set on the reference line, and a cross line for crossing the reference line on a predetermined period;
moves the relative position between the reference point and the cross line by a predetermined moving distance in response to an event occurring with the progress of the game; and
when the cross line coincides with the reference point, determines that the condition occurs and changes the status of the player character.

11. The gaming machine as claimed in claim 10, wherein the display controller displays the relative positional relationship between the reference point and the cross line on the display in response to entry operation of the player through the operation unit.

12. The gaming machine as claimed in claim 10, wherein the status controller:
provides a plurality of the cross lines; and
moves the relative position between the reference point and each of the plurality of cross lines by a predetermined moving distance in response to an event occurring with the progress of the game.

13. The gaming machine as claimed in claim 12, wherein the status controller changes the status of the character player to a different status in response to the number of the cross lines coinciding with the reference point.

14. The gaming machine as claimed in claim 12, wherein the status controller changes the status of the character player to a different status in response to which of the cross lines coincides with the reference point.

15. The gaming machine as claimed in claim 10, wherein the status controller determines that an event occurs as a battle is fought between the player character and the enemy character, and moves the relative position between the reference point and the cross line by the predetermined moving distance.

16. The gaming machine as claimed in claim 10, wherein the status controller determines that an event occurs as the player character encounters a specific episode with the progress of the game, and moves the relative position between the reference point and the cross line by the predetermined moving distance.

17. The gaming machine as claimed in claim 10, wherein the status controller determines that an event occurs as a map of the game in which the player character is positioned is switched, and moves the relative position between the reference point and the cross line by the predetermined moving distance.

18. The gaming machine as claimed in claim 10, wherein the status controller determines that an event occurs in response to the moving distance of the player character on a map in the game, and moves the relative position between the reference point and the cross line by the predetermined moving distance.

19. The gaming machine as claimed in claim 10, wherein the status controller changes the status of the player character when a battle is not fought between the player character and the enemy character.

20. The gaming machine as claimed in claim 10, wherein the status controller changes the period on which the cross line crosses the reference line if the player character is equipped with a predetermined accessory.

21. The gaming machine as claimed in claim 10, wherein the status controller changes the status of the player character independently of changing the status based on the condition when the player character uses a predetermined item.

22. A computer-readable program product for storing a gaming program for causing a computer to execute the steps of:
allowing a player to enter an action command of a player character to proceed a game;
displaying the player character and an enemy character on a display for displaying the progress of the game and displaying a battle between the player character and the enemy character; and
changing the status of the player character when a predetermined condition is satisfied.

23. The program product as claimed in claim 22, wherein in changing the status, whether or not the condition is satisfied is determined based on a number of times a battle has been fought between the player character and the enemy character.

24. The program product as claimed in claim 22, wherein in changing the status, whether or not the condition is satisfied is determined based on a number of times the player character has encountered a specific episode with the progress of the game.

25. The program product as claimed in claim 22, wherein in changing the status, whether or not the condition is satisfied is determined based on a number of times a map of the game in which the player character is positioned has been switched.

26. The program product as claimed in claim 22, wherein in changing the status, whether or not the condition is satisfied is determined based on a moving distance of the player character on a map in the game.

27. The program product as claimed in claim 22, wherein in changing the status, the status of the player character is changed during a period when a battle is not fought between the player character and the enemy character.

28. The program product as claimed in claim 22, wherein in changing the status, the condition is changed when the player character is equipped with a predetermined accessory.

29. The program product as claimed in claim 22, wherein in changing the status, the status of the player character is changed independently of changing the status based on the condition when the player character uses a predetermined item.

30. The program product as claimed in claim 22, wherein a parameter indicating a skill of the player character concerning a battle is stored,
wherein a status table for indicating the relationship among different types of status to which the player character can belong, the effect of each of the different types of status on the parameter, and a condition for changing the status of the player character to at least one of the different types of status is stored, and
wherein in changing the status, when the condition indicated in the status table is satisfied, the status of the player character is changed to the status corresponding to the condition which is satisfied.

31. The program product as claimed in claim 22, wherein in changing the status:
a reference line, a reference point set on the reference line, and a cross line for crossing the reference line on a predetermined period are virtually provided;
the relative position between the reference point and the cross line is moved by a predetermined moving distance in response to an event occurring with the progress of the game; and
when the cross line coincides with the reference point, the condition is determined to occur, and the status of the player character is changed.

32. The program product as claimed in claim 31, wherein the relative positional relationship between the reference point and the cross line is displayed on the display in response to entry operation of the player.

33. The program product as claimed in claim 31, wherein in changing the status:
a plurality of the cross lines are provided; and
the relative position between the reference point and each of the plurality of cross lines is moved by a predetermined moving distance in response to an event occurring with the progress of the game.

34. The program product as claimed in claim 33, wherein in changing the status, the status of the character player is changed to a different status in response to the number of the cross lines coinciding with the reference point.

35. The program product as claimed in claim 33, wherein in changing the status, the status of the character player is changed to a different status in response to which of the cross lines coincides with the reference point.

36. The program product as claimed in claim 31, wherein in changing the status, an event is determined to occur as a battle is fought between the player character and the enemy character, and the relative position between the reference point and the cross line is moved by the predetermined moving distance.

37. The program product as claimed in claim 31, wherein in changing the status, an event is determined to occur as the player character encounters a specific episode with the progress of the game, and the relative position between the reference point and the cross line is moved by the predetermined moving distance.

38. The program product as claimed in claim 31, wherein in changing the status, an event is determined to occur as a map of the game in which the player character is positioned is switched, and the relative position between the reference point and the cross line is moved by the predetermined moving distance.

39. The program product as claimed in claim 31, wherein in changing the status, an event is determined to occur in response to the moving distance of the player character on the map in the game, and the relative position between the reference point and the cross line is moved by the predetermined moving distance.

40. The program product as claimed in claim 31, wherein in changing the status, the status of the player character is changed when a battle is not fought between the player character and the enemy character.

41. The program product as claimed in claim 31, wherein in changing the status, the period on which the cross line crosses the reference line is changed if the player character is equipped with a predetermined accessory.

42. The program product as claimed in claim 31, wherein in changing the status, the status of the player character is changed independently of changing the status based on the condition if the player character uses a predetermined item.
